(19) United States
(12) Patent Application Publication
(10) Pub. No.: US 2024/0408580 A1
(43) Pub. Date: Dec. 12, 2024

(54) HYDROGEN PERMEABLE, INTERMETALLIC DIFFUSION BARRIERS USED IN BODY-CENTERED CUBIC METAL MEMBRANES

(71) Applicant: Colorado School of Mines, Golden, CO (US)

(72) Inventors: Colin A. Wolden, Denver, CO (US); Adam Job, Helena, MT (US); James Douglas Way, Boulder, CO (US)

(21) Appl. No.: 18/741,630

(22) Filed: Jun. 12, 2024

Related U.S. Application Data
(60) Provisional application No. 63/472,530, filed on Jun. 12, 2023.

(51) Int. Cl. B01J 23/44; B01D 53/22; B01D 67/00; B01D 69/02; B01D 69/12; B01D 69/14; B01D 71/02; B01J 23/22; B01J 27/24; B01J 35/00; B01J 35/50; B01J 37/02; B01J 37/34

(52) U.S. Cl. CPC B01J 23/44; B01D 53/228; B01D 67/0072; B01D 69/02; B01D 69/1214; B01D 69/1216; B01D 69/145; B01D 71/0221; B01D 71/0227; B01D 71/05; B01J 23/22; B01J 27/24; B01J 35/19; B01J 35/50; B01J 37/0225; B01J 37/0228; B01J 37/0244; B01J 37/347; B01D 2323/081; B01D 2325/04

(57) ABSTRACT

A composite metal membrane for use in hydrogen purification includes a body-centered cubic metal layer, one or more catalyst layers, and one or more hydrogen-permeable, intermetallic diffusion barriers deposited between the body-centered cubic metal layer and the one or more catalyst layers. The body-centered cubic metal layer can include a group 5 metal. The one or more hydrogen-permeable, intermetallic diffusion barriers can each include a group 4 nitride, which may be applied via reactive sputtering. The one or more catalyst layers can each include a platinum group metal. The composite metal membrane may be symmetric in configuration, with a first hydrogen-permeable, intermetallic diffusion barrier between the body-centered cubic metal layer and a first catalyst layer, and a second hydrogen-permeable, intermetallic diffusion barrier between the body-centered cubic metal layer and a second catalyst layer.

### CROSS-REFERENCE TO RELATED APPLICATIONS

This U.S. Non-Provisional Patent Application claims the benefit of priority under 35 U.S.C. § 119(e) of U.S. Provisional Patent Application Ser. No. 63/472,530, filed Jun. 12, 2023, the entire disclosure of which is hereby incorporated by reference.

### GOVERNMENT LICENSE RIGHTS

This invention was made with government support under grant number DE-AR0001368 awarded by the United States Department of Energy through the Advanced Research Projects Agency-Energy (ARPA-E). The government has certain rights in the invention.

### FIELD

This disclosure generally relates to hydrogen-permeable, intermetallic diffusion barriers used in body centered cubic (BCC) metal membranes.

### BACKGROUND

The background description includes information that may be useful in understanding the present inventive subject matter. It is not an admission that any of the information provided herein is prior art or relevant to the presently claimed disclosure, or that any publication specifically or implicitly referenced is prior art.

Determining the required fuel density, temperature, and energy confinement time of a plasma fuel is necessary to create a viable fusion energy system. Research and development into fusion energy systems has attempted to establish both the technical and commercial viability of (i) the required technologies and subsystems between fusion plasma and the balance of plant operation, (ii) cost-effective, high-efficiency, high-duty-cycle driver technologies, and (iii) novel fusion materials and advanced manufacturing of the same. In some fusion energy systems, practical deployment of fusion energy-based power necessitates the effective management of tritium resources. Tritium is an isotope of hydrogen (3H) with a short half-life that, when used as a fusion fuel, must be continuously generated, recovered, and recycled in any tritium-fueled fusion power plant. One option is to employ interfacial-engineered membranes for efficient tritium extraction. Dense metallic membranes can separate hydrogen gas (H₂) from other gases due to a high level of permeability and infinite H₂ selectivity. Known metallic membranes, however, include foils based on palladium (Pd) and its alloys (e.g., palladium-silver, or PdAg, alloys), which are often prohibitively expensive due to the ever-increasing cost of palladium and other platinum metals or noble metals in general.

### SUMMARY

As such, there exists a need for metallic membranes that promote hydrogen purification. The membranes should be capable of hydrogen permeability while resisting interdiffusion of the layers at increased or elevated temperatures. The membranes should be less costly than known platinum metal (e.g., including ruthenium (Ru), rhodium (Rh), palladium (Pd), osmium (Os), iridium (Ir), and platinum (Pt)) foils and/or noble metal foils (e.g., including platinum metals, silver (Ag), and gold (Au)).

Aspects of the present disclosure are directed to hydrogen-permeable, intermetallic diffusion barriers used in body centered cubic (BCC) metal membranes. Aspects of the present disclosure are also directed to hydrogen-permeable, interdiffusion barriers for use in stable composite BCC membranes. Composite membranes for efficient tritium extraction from breeder media are described in the present application, which are engineered for high performance, stability, and environmental capability.

Aspects of the present disclosure are also directed to using reactive sputtering to modify surfaces and impart desired functionality of the composite membranes. In this regard, the present disclosure is directed to enabling a lower-cost and safer fusion energy system by eliminating major fuel cycle components and reducing tritium inventory, release, and required breeding ratios, thus leading to a safer, carbon-free, abundant energy source for developed and emerging economies.

Aspects of the present disclosure are also directed to a method or process of acquiring (e.g., fabricating or otherwise obtaining) the composite membranes and/or acquiring (e.g., fabricating or otherwise obtaining) layers or components of the composite membranes as described throughout the present disclosure. Aspects of the present disclosure are further directed to a method or process of using or utilizing the composite membranes in fusion energy systems, including for the stable and effective permeation of hydrogen at high temperatures as described throughout the present disclosure.

Embodiments of the present disclosure are directed to a composite metal membrane having a symmetric configuration of layers. For example, a primary layer of the composite metal membrane may include a BCC metal such as, but not limited to, a group 5 metal such as vanadium (V), niobium (Nb), or tantalum (Ta). The primary layer may be coated on a first surface and an opposing second surface by a nitride layer; the nitride layer may include, by way of non-limiting example, a nitride of a group 4 transition metal, i.e., a nitride of zirconium (Zr) (e.g., ZrN), titanium (Ti) (e.g., TiN), or hafnium (Hf) (e.g., HfN). Each of the nitride layers may be coated with a platinum group metal (PGM) catalyst. In one non-limiting example, the composite membrane includes a palladium-zirconium nitride-vanadium-zirconium nitride-palladium (Pd—ZrN—V—ZrN—Pd) layer structure.

Embodiments of the present disclosure are also directed to a composite membrane with operating and/or deposition temperatures between approximately room temperature (RT) and 500 degrees Celsius (° C.) without rapid interdiffusion. In some embodiments, the composite membrane has an operating and/or deposition temperature from about 15° C. to about 500° C. For example, the composite membrane may have operating and/or deposition temperatures of approximately 15° C., 20° C., 25° C., 30° C., 35° C., 40° C., 45° C., 50° C., 55° C., 60° C., 65° C., 70° C., 75° C., 80° C., 85° C., 90° C., 95° C., 100° C., 105° C., 110° C., 115° C., 120° C., 125° C., 130° C., 135° C., 140° C., 145° C., 150° C., 155° C., 160° C., 165° C., 170° C., 175° C., 180° C., 185° C., 190° C., 195° C., 200° C., 205° C., 210° C., 215° C., 220° C., 225° C., 230° C., 235° C., 240° C., 245° C., 250° C., 255° C., 260° C., 265° C., 270° C., 275° C., 280° C., 285° C., 290° C., 295° C., 300° C., 305° C., 310° C., 315° C., 320° C., 325° C., 330° C., 335° C., 340° C., 345° C., 350° C., 355° C., 360° C., 365° C., 370° C., 375° C., 380° C., 385° C., 390° C., 395° C., 400° C., 405° C., 410° C., 415° C., 420° C., 425° C., 430° C., 435° C., 440° C., 445° C., 450° C., 455° C., 460° C., 465° C., 470° C., 475° C., 480° C., 485° C., 490° C., 495° C., or 500° C., or any temperature in any range bounded by any two of these values. In other embodiments, the composite membrane has an operating and/or deposition temperature of about 350° C. to about 450° C.

Embodiments of the present disclosure are also directed to a composite membrane able to operate continuously for periods of time up to at least about 200 hours. In operation, the composite membrane may operate continuously for at least about 5 hours, at least about 10 hours, at least about 15 hours, at least about 20 hours, at least about 25 hours, at least about 30 hours, at least about 35 hours, at least about 40 hours, at least about 45 hours, at least about 50 hours, at least about 55 hours, at least about 60 hours, at least about 65 hours, at least about 70 hours, at least about 75 hours, at least about 80 hours, at least about 85 hours, at least about 90 hours, at least about 95 hours, at least about 100 hours, at least about 105 hours, at least about 110 hours, at least about 115 hours, at least about 120 hours, at least about 125 hours, at least about 130 hours, at least about 135 hours, at least about 140 hours, at least about 145 hours, at least about 150 hours, at least about 155 hours, at least about 160 hours, at least about 165 hours, at least about 170 hours, at least about 175 hours, at least about 180 hours, at least about 185 hours, at least about 195 hours, or at least about 200 hours.

Embodiments of the present disclosure are also directed to a composite membrane with layers that each have a thickness of about 10 nanometers (nm) to about 100 nm in thickness, or in any range having a lower bound of any whole number of nanometers from 10 nm to 100 nm and an upper bound of any other whole number of nanometers from 10 nm to 100 nm. For example, the thickness of any layer may be between 10 nm and 100 nm, 10 nm and 95 nm, 10 nm and 90 nm, 10 nm and 85 nm, 10 nm and 80 nm, 10 nm and 75 nm, 10 nm and 70 nm, 10 nm and 65 nm, 10 nm and 60 nm, 10 nm and 55 nm, 10 nm and 50 nm, 10 nm and 45 nm, 10 nm and 40 nm, 10 nm and 35 nm, 10 nm and 30 nm, 10 nm and 25 nm, 10 nm and 20 nm, 10 nm and 15 nm, 15 nm and 100 nm, 15 nm and 95 nm, 15 nm and 90 nm, 15 nm and 85 nm, 15 nm and 80 nm, 15 nm and 75 nm, 15 nm and 70 nm, 15 nm and 65 nm, 15 nm and 60 nm, 15 nm and 55 nm, 15 nm and 50 nm, 15 nm and 45 nm, 15 nm and 40 nm, 15 nm and 35 nm, 15 nm and 30 nm, 15 nm and 25 nm, 15 nm and 20 nm, 20 nm and 100 nm, 20 nm and 95 nm, 20 nm and 90 nm, 20 nm and 85 nm, 20 nm and 80 nm, 20 nm and 75 nm, 20 nm and 70 nm, 20 nm and 65 nm, 20 nm and 60 nm, 20 nm and 55 nm, 20 nm and 50 nm, 20 nm and 45 nm, 20 nm and 40 nm, 20 nm and 35 nm, 20 nm and 30 nm, 20 nm and 25 nm, 25 nm and 100 nm, 25 nm and 95 nm, 25 nm and 90 nm, 25 nm and 85 nm, 25 nm and 80 nm, 25 nm and 75 nm, 25 nm and 70 nm, 25 nm and 65 nm, 25 nm and 60 nm, 25 nm and 55 nm, 25 nm and 50 nm, 25 nm and 45 nm, 25 nm and 40 nm, 25 nm and 35 nm, 25 nm and 30 nm, 30 nm and 100 nm, 30 nm and 95 nm, 30 nm and 90 nm, 30 nm and 85 nm, 30 nm and 80 nm, 30 nm and 75 nm, 30 nm and 70 nm, 30 nm and 65 nm, 30 nm and 60 nm, 30 nm and 55 nm, 30 nm and 50 nm, 30 nm and 45 nm, 30 nm and 40 nm, 30 nm and 35 nm, 35 nm and 100 nm, 35 nm and 95 nm, 35 nm and 90 nm, 35 nm and 85 nm, 35 nm and 80 nm, 35 nm and 75 nm, 35 nm and 70 nm, 35 nm and 65 nm, 35 nm and 60 nm, 35 nm and 55 nm, 35 nm and 50 nm, 35 nm and 45 nm, 35 nm and 40 nm, 40 nm and 100 nm, 40 nm and 95 nm, 40 nm and 90 nm, 40 nm and 85 nm, 40 nm and 80 nm, 40 nm and 75 nm, 40 nm and 70 nm, 40 nm and 65 nm, 40 nm and 60 nm, 40 nm and 55 nm, 40 nm and 50 nm, 40 nm and 45 nm, 45 nm and 100 nm, 45 nm and 95 nm, 45 nm and 90 nm, 45 nm and 85 nm, 45 nm and 80 nm, 45 nm and 75 nm, 45 nm and 70 nm, 45 nm and 65 nm, 45 nm and 60 nm, 45 nm and 55 nm, 45 nm and 50 nm, 50 nm and 100 nm, 50 nm and 95 nm, 50 nm and 90 nm, 50 nm and 85 nm, 50 nm and 80 nm, 50 nm and 75 nm, 50 nm and 70 nm, 50 nm and 65 nm, 50 nm and 60 nm, 50 nm and 55 nm, 55 nm and 100 nm, 55 nm and 95 nm, 55 nm and 90 nm, 55 nm and 85 nm, 55 nm and 80 nm, 55 nm and 75 nm, 55 nm and 70 nm, 55 nm and 65 nm, 55 nm and 60 nm, 60 nm and 100 nm, 60 nm and 95 nm, 60 nm and 90 nm, 60 nm and 85 nm, 60 nm and 80 nm, 60 nm and 75 nm, 60 nm and 70 nm, 60 nm and 65 nm, 65 nm and 100 nm, 65 nm and 95 nm, 65 nm and 90 nm, 65 nm and 85 nm, 65 nm and 80 nm, 65 nm and 75 nm, 65 nm and 70 nm, 70 nm and 100 nm, 70 nm and 95 nm, 70 nm and 90 nm, 70 nm and 85 nm, 70 nm and 80 nm, 70 nm and 75 nm, 75 nm and 100 nm, 75 nm and 95 nm, 75 nm and 90 nm, 75 nm and 85 nm, 75 nm and 80 nm, 80 nm and 100 nm, 80 nm and 95 nm, 80 nm and 90 nm, 80 nm and 85 nm, 90 nm and 100 nm, 90 nm and 95 nm, or 95 nm and 100 nm.

A first aspect of the present disclosure is to provide a composite metal membrane for stable and effective permeation of hydrogen during hydrogen purification to produce high purity hydrogen. The composite metal membrane comprises a metal foil layer comprising (e.g., formed from, or the like) a body-centered cubic metal; at least one catalyst layer comprising (e.g., formed from, or the like) a platinum group metal; and at least one hydrogen-permeable, intermetallic diffusion barrier disposed between the metal foil layer and the at least one catalyst layer and comprising (e.g., formed from, or the like) a group 4 nitride.

The composite metal membrane of the first aspect may include, optionally, wherein the body-centered cubic metal is selected from a group comprising vanadium (V), niobium (Nb), tantalum (Ta), and combinations thereof. In some embodiments, the body-centered cubic metal is selected from the group consisting of V, Nb, Ta, and combinations thereof.

The composite metal membrane of the first aspect may include one or more of the previous embodiments and, optionally, wherein the body-centered cubic metal is V.

The composite metal membrane of the first aspect may include one or more of the previous embodiments and, optionally, wherein the body-centered cubic metal is Nb.

The composite metal membrane of the first aspect may include one or more of the previous embodiments and, optionally, wherein the body-centered cubic metal is Ta.

The composite metal membrane of the first aspect may include one or more of the previous embodiments and, optionally, wherein the platinum group metal is selected from a group comprising palladium (Pd), platinum (Pt), ruthenium (Ru), and combinations thereof. In some embodiments, the platinum group metal is selected from the group consisting of Pd, Pt, Ru, and combinations thereof.

The composite metal membrane of the first aspect may include one or more of the previous embodiments and, optionally, wherein the platinum group metal is Pd.

The composite metal membrane of the first aspect may include one or more of the previous embodiments and, optionally, wherein the platinum group metal is Pt.

The composite metal membrane of the first aspect may include one or more of the previous embodiments and, optionally, wherein the platinum group metal is Ru.

The composite metal membrane of the first aspect may include one or more of the previous embodiments and, optionally, wherein the group 4 nitride is selected from a group comprising zirconium nitride (ZrN), titanium nitride (TiN), hafnium nitride (HfN), and combinations thereof. In some embodiments, the group 4 nitride is selected from the group consisting of ZrN, TiN, HfN, and combinations thereof.

The composite metal membrane of the first aspect may include one or more of the previous embodiments and, optionally, wherein the group 4 nitride is ZrN.

The composite metal membrane of the first aspect may include one or more of the previous embodiments and, optionally, wherein the group 4 nitride is TiN.

The composite metal membrane of the first aspect may include one or more of the previous embodiments and, optionally, wherein the group 4 nitride is HfN.

The composite metal membrane of the first aspect may include one or more of the previous embodiments and, optionally, wherein the at least one hydrogen-permeable, intermetallic diffusion barrier has a thickness of about 20 nanometers to about 40 nanometers.

The composite metal membrane of the first aspect may include one or more of the previous embodiments and, optionally, wherein the at least one catalyst layer comprises a first catalyst layer and a second catalyst layer, and wherein the at least one hydrogen-permeable, intermetallic diffusion barrier comprises a first hydrogen-permeable, intermetallic diffusion barrier, disposed between the first catalyst layer and a first side of the metal foil layer, and a second hydrogen-permeable, intermetallic diffusion barrier, disposed between the second catalyst layer and a second side of the metal foil layer.

A second aspect of the present disclosure is a method for fabricating a composite metal membrane for stable and effective permeation of hydrogen during hydrogen purification to produce high purity hydrogen. The method may include, but is not limited to, (a) forming a metal foil layer from a body-centered cubic group 5 metal. The method may include, but is not limited to, (b) depositing a group 4 nitride on the metal foil layer to form at least one hydrogen-permeable, intermetallic diffusion barrier. The method may include, but is not limited to, (c) depositing a platinum group metal on the at least one hydrogen-permeable, intermetallic diffusion barrier to form at least one catalyst layer.

The method of the second aspect may include, optionally, wherein step (b) is carried out at a temperature from about 350° C. to about 450° C.

The method of the second aspect may include, optionally, wherein the temperature is about 400° C.

The method of the second aspect may include, optionally, wherein at least a portion of step (b) is carried out by reactive sputtering.

The method of the second aspect may include, optionally, wherein the reactive sputtering is carried out in an atmosphere comprising no more than about 4% nitrogen gas (N₂).

The method of the second aspect may include one or more of the previous embodiments and, optionally, wherein the reactive sputtering is carried out in an atmosphere comprising at least about 10% nitrogen gas (N₂).

The method of the second aspect may include one or more of the previous embodiments and, optionally, wherein step (b) comprises: forming a first hydrogen-permeable, intermetallic diffusion barrier on a first side of the metal foil layer; and forming a second hydrogen-permeable, intermetallic diffusion barrier on a second side of the metal foil layer. In addition, optionally, step (c) comprises: forming a first catalyst layer on the first hydrogen-permeable, intermetallic diffusion barrier; and forming a second catalyst layer on the second hydrogen-permeable, intermetallic diffusion barrier.

A third aspect of the present disclosure is to provide a composite metal membrane for stable and effective permeation of hydrogen during hydrogen purification to produce high purity hydrogen. The composite metal membrane comprises a metal foil layer comprising a body-centered cubic metal; a first platinum group metal catalyst layer; a second platinum group metal catalyst layer; a first group 4 nitride layer forming a first hydrogen-permeable, intermetallic diffusion barrier, the first group 4 nitride layer disposed between a first side of the metal foil layer and the first platinum group metal catalyst layer; and a second group 4 nitride layer forming a second hydrogen-permeable, intermetallic diffusion barrier, the second group 4 nitride layer disposed between a second side of the metal foil layer and the second platinum group metal catalyst layer.

The composite metal membrane of the third aspect may include, optionally, wherein the body-centered cubic metal is a group 5 metal selected from a group including vanadium (V), niobium (Nb), tantalum (Ta), and combinations thereof. In some embodiments, the body-centered cubic metal is selected from the group consisting of V, Nb, Ta, and combinations thereof.

The composite metal membrane of the third aspect may include one or more of the previous embodiments and, optionally, wherein the first platinum group metal catalyst layer and the second platinum group metal catalyst layer each comprise a platinum group metal selected from a group including palladium (Pd), platinum (Pt), ruthenium (Ru), and combinations thereof. In some embodiments, the first platinum group metal catalyst layer and the second platinum group metal catalyst layer each comprise a platinum group metal selected from a group consisting of Pd, Pt, Ru, and combinations thereof.

The composite metal membrane of the third aspect may include one or more of the previous embodiments and, optionally, wherein the first group 4 nitride layer and the second group 4 nitride layer each comprise a group 4 nitride selected from a group including zirconium nitride (ZrN), titanium nitride (TiN), hafnium nitride (HfN), and combinations thereof. In some embodiments, the first group 4 nitride layer and the second group 4 nitride layer each comprise a group 4 nitride selected from the group consisting of ZrN, TiN, HfN, and combinations thereof.

The composite metal membrane of the third aspect may include one or more of the previous embodiments and, optionally, wherein the high purity hydrogen produced by the composite metal membrane that promotes hydrogen purification is usable in applications comprising proton-exchange membrane (PEM) fuel cells, hydrocarbon processing, semiconductor processing, and nuclear fuel cycles.

A fourth aspect of the present disclosure is to provide a composite metal membrane for the stable and effective permeation of hydrogen at high temperatures during hydrogen purification to produce high purity hydrogen. The composite metal membrane comprises at least one hydrogen-permeable, intermetallic diffusion barrier disposed between at least one metal foil and at least one catalyst.

The composite metal membrane of the fourth aspect may include, optionally, wherein the at least one hydrogen-permeable, intermetallic diffusion barrier comprises a group 4 nitride including a zirconium nitride (ZrN), a titanium nitride (TiN), and a hafnium nitride (HfN).

The composite metal membrane of the fourth aspect may include one or more of the previous embodiments and, optionally, the at least one metal foil comprises a body centered cubic (BCC) metal including a vanadium (V), a niobium (Nb), or a tantalum (Ta).

The composite metal membrane of the fourth aspect may include one or more of the previous embodiments and, optionally further comprises a platinum group metal (PGM) catalyst including a palladium (Pd), a platinum (Pt), and a ruthenium (Ru).

A fifth aspect of the present disclosure is to provide a method for manufacturing the composite metal membrane of the fourth aspect.

A sixth aspect of the present disclosure is to provide a method for using the composite metal membrane of the fourth aspect in a fusion energy system.

A seventh aspect of the present disclosure is to provide a composite metal membrane for the stable and effective permeation of hydrogen at high temperatures during hydrogen purification to produce high purity hydrogen. The composite metal membrane comprises at least one metal foil including a body centered cubic (BCC) foil; at least one catalyst including a platinum group metal (PGM) catalyst; and at least one hydrogen-permeable, intermetallic diffusion barrier including a group 4 nitride disposed between the at least one metal foil and the at least one catalyst.

An eighth aspect of the present disclosure is to provide a composite metal membrane for the stable and effective permeation of hydrogen at high temperatures during hydrogen purification to produce high purity hydrogen. The composite metal membrane comprises a vanadium (V) foil; a first palladium (Pd) catalyst on a first side of the V foil; a second Pd catalyst on a second side of the V foil; and a first hydrogen-permeable, intermetallic zirconium nitride (ZrN) diffusion barrier disposed between the V foil and the first Pd catalyst on the first side of the V foil; and a second hydrogen-permeable, intermetallic ZrN diffusion barrier disposed between the V foil and the second Pd catalyst on the second side of the V foil.

The phrases “at least one”, “one or more”, and “and/or” are open-ended expressions that are both conjunctive and disjunctive in operation. For example, each of the expressions “at least one of A, B and C”, “at least one of A, B, or C”, “one or more of A, B, and C”, “one or more of A, B, or C”, “A, B, and/or C”, and “A, B, or C” means A alone, B alone, C alone, A and B together, A and C together, B and C together, or A, B and C together. When each one of A, B, and C in the above expressions refers to an element, such as X, Y, and Z, or class of elements, such as X₁—Xₙ, Y₁-Yₘ, and Z₁-Z₀, the phrase is intended to refer to a single element selected from X, Y, and Z, a combination of elements selected from the same class (e.g., X₁ and X₂) as well as a combination of elements selected from two or more classes (e.g., Y₁ and Z₀)

Unless otherwise indicated, all numbers expressing quantities, dimensions, conditions, and so forth used in the specification and claims are to be understood as being modified in all instances by the term “about.”

The use of “substantially” in the present disclosure, when referring to a measurable quantity (e.g., a diameter or other distance) and used for purposes of comparison, is intended to mean within 5% of the comparative quantity. The terms “substantially similar to,” “substantially the same as,” and “substantially equal to,” as used herein, should be interpreted as if explicitly reciting and encompassing the special case in which the items of comparison are “similar to,” “the same as” and “equal to,” respectively.

As used herein, unless otherwise specified, the terms “about,” “approximately,” etc., when used in relation to numerical limitations or ranges, mean that the recited limitation or range may vary by up to 10%. By way of non-limiting example, “about 750” can mean as little as 675 or as much as 825, or any value therebetween. When used in relation to ratios or relationships between two or more numerical limitations or ranges, the terms “about,” “approximately,” etc. mean that each of the limitations or ranges may vary by up to 10%; by way of non-limiting example, a statement that two quantities are “approximately equal” can mean that a ratio between the two quantities is as little as 0.9:1.1 or as much as 1.1:0.9 (or any value therebetween), and a statement that a four-way ratio is “about 5:3:1:1” can mean that the first number in the ratio can be any value of at least 4.5 and no more than 5.5, the second number in the ratio can be any value of at least 2.7 and no more than 3.3, and so on.

All percentages and ratios are calculated by total composition weight, unless indicated otherwise.

It should be understood that every maximum numerical limitation given throughout this disclosure is deemed to include each and every lower numerical limitation as an alternative, as if such lower numerical limitations were expressly written herein. Every minimum numerical limitation given throughout this disclosure is deemed to include each and every higher numerical limitation as an alternative, as if such higher numerical limitations were expressly written herein. Every numerical range given throughout this disclosure is deemed to include each and every narrower numerical range that falls within such broader numerical range, as if such narrower numerical ranges were all expressly written herein. By way of example, the phrase from about 2 to about 4 includes the whole number and/or integer ranges from about 2 to about 3, from about 3 to about 4 and each possible range based on real (e.g., irrational and/or rational) numbers, such as from about 2.1 to about 4.9, from about 2.1 to about 3.4, and so on.

Unless otherwise noted, all component or composition levels are in reference to the active portion of that component or composition and are exclusive of impurities, for example, residual solvents or by-products, which may be present in commercially available sources of such components or compositions.

The term “a” or “an” entity, as used herein, refers to one or more of that entity. As such, the terms “a” (or “an”), “one or more” and “at least one” can be used interchangeably herein.

The use of “including,” “comprising,” or “having” and variations thereof herein is meant to encompass the items listed thereafter and equivalents thereof as well as additional items. Accordingly, the terms “including,” “comprising,” or “having” and variations thereof can be used interchangeably herein. The use of “engaged with” and variations thereof herein is meant to encompass any direct or indirect connections between components.

It shall be understood that the term “means” as used herein shall be given its broadest possible interpretation in accordance with 35 U.S.C. § 112(f). Accordingly, a claim incorporating the term “means” shall cover all structures, materials, or acts set forth herein, and all of the equivalents thereof. Further, the structures, materials, or acts and the equivalents thereof shall include all those described in the summary, brief description of the drawings, detailed description, abstract, and claims themselves.

All external references are hereby incorporated by reference in their entirety whether explicitly stated or not.

These and other advantages will be apparent from the disclosure contained herein. The above-described embodiments, objectives, and configurations are neither complete nor exhaustive. It is intended neither to identify key or critical elements of the disclosure nor to delineate the scope of the disclosure but to present selected concepts of the disclosure in a simplified form as an introduction to the more detailed description presented below. The Summary is neither intended nor should it be construed as being representative of the full extent and scope of the present disclosure. Moreover, references made herein to “the present disclosure,” or aspects thereof should be understood to mean certain embodiments of the present disclosure and should not necessarily be construed as limiting all embodiments to a particular description. The present disclosure is set forth in various levels of detail in the Summary as well as in the attached drawings and the Detailed Description and no limitation as to the scope of the present disclosure is intended by either the inclusion or non-inclusion of elements, components, etc. in this Summary. Additional aspects of the present disclosure will become more readily apparent from the Detailed Description, particularly when taken together with the drawings.

It is to be appreciated that any embodiment, feature, or aspect described herein can be claimed in combination with any other embodiment(s), feature(s), or aspect(s) as described herein, regardless of whether the features or aspects come from the same described embodiment. For example, any one or more aspects described herein can be combined with any other one or more aspects described herein. In addition, any one or more features described herein can be combined with any other one or more features described herein. Further, any one or more embodiments described herein can be combined with any other one or more embodiments described herein.

### BRIEF DESCRIPTION OF THE DRAWINGS

Those of skill in the art will recognize that the following description is merely illustrative of the principles of the disclosure, which may be applied in various ways to provide many different alternative embodiments. This description is made for illustrating the general principles of the teachings of this disclosure and is not meant to limit the inventive concepts disclosed herein.

The accompanying drawings, which are incorporated in and constitute a part of the specification, illustrate embodiments and together with the general description of the disclosure given above and the detailed description of the drawings given below, serve to explain the principles of the disclosure.

FIG. 1 illustrates a flow diagram of a method or process for the fabrication of a membrane, in accordance with one or more embodiments of the present disclosure.

FIG. 2A illustrates a membrane fabricated with the method or process of FIG. 1, in accordance with one or more embodiments of the present disclosure;

FIG. 2B illustrates a membrane fabricated with the method or process of FIG. 1, in accordance with one or more embodiments of the present disclosure;

FIG. 3 illustrates a graphical view of deposition rate versus percentage N₂ by volume (vol % N₂) of a group 4 nitride such as ZrN, for both deposition rate and resistivity and at both room temperature and at 400° C.;

FIG. 4 illustrates a graphical view of X-ray diffraction (XRD) patterns based on relative intensity versus 20 angle of a group 4 nitride such as ZrN, in both a metallic regime and a compound regime, and at both room temperature and at 400° C.;

FIG. 5A illustrates a graphical view of H₂ flux versus driving force for a control PdCu foil and an asymmetric composite membrane;

FIG. 5B illustrates a graphical view of permeance versus 1/group 4 nitride thickness in an asymmetric composite membrane, as compared to a control PdCu foil;

FIG. 6 illustrates a graphical view of permeability versus time for symmetric composite membranes according to the present disclosure, the symmetric composite membranes in both a metallic regime and a compound regime, and at both room temperature and at 400° C.;

FIG. 7 illustrates a graphical view of permeability versus 1/temperature for symmetric composite membranes according to the present disclosure, the symmetric composite membranes in both a metallic regime and a compound regime, as compared to a theoretical V foil and a theoretical Pd foil;

FIG. 8A illustrates a graphical view of H₂ flux versus driving force for a symmetric composite membrane according to the present disclosure, the symmetric composite membrane having an operating time of at least 200 hours;

FIG. 8B illustrates a graphical view of XRD patterns based on relative intensity versus 2θ angle for a symmetric composite membrane both before and after an operating time of at least 200 hours;

FIG. 9A illustrates a graphical view of relative intensity versus sputter time for an as-deposited (or as-fabricated) symmetric composite membrane according to the present disclosure;

FIG. 9B illustrates a graphical view of relative intensity versus sputter time for a symmetric composite membrane according to the present disclosure, the symmetric composite membrane at 400° C. and for 15 hours;

FIG. 9C illustrates a graphical view of relative intensity versus sputter time for a symmetric composite membrane according to the present disclosure, the symmetric composite membrane at 500° C. and for 15 hours;

FIG. 9D illustrates a graphical view of relative intensity versus sputter time for oxygen traces of symmetric composite membranes according to the present disclosure, the composite membranes either being as-deposited (or as-fabricated), at 400° C. and for 15 hours, or at 500° C. and for 15 hours; and

FIG. 10 illustrates a set of transmission electron microscopy (TEM) images for symmetric composite membranes according to the present disclosure, the composite membranes either being as-deposited (or as-fabricated), at 400° C. and for 15 hours, or at 500° C. and for 15 hours.

It should be understood that the drawings are not necessarily to scale, and various dimensions may be altered. In certain instances, details that are not necessary for an understanding of the disclosure or that render other details difficult to perceive may have been omitted. It should be understood, of course, that the disclosure is not necessarily limited to the particular embodiments illustrated herein.

| Reference Number | Component |
|---|---|
| 100 | Process Flow Diagram |
| 102, 104, 106 | Step |
| 108, 110, 112 | Step |
| 200 | Symmetric Membrane |
| 202 | Membrane Layer |
| 204 | Membrane Layer |
| 206 | Membrane Layer |
| 210 | Asymmetric Membrane |
| 212 | Membrane Layer |
| 300 | Graph |
| 302 | Point, Pure Zr Resistivity |
| 304 | Point, Pure Zr Deposition Rate |
| 306 | Line, Zr Deposition Rate, Room Temperature |
| 308 | Line, Zr Resistivity, Room Temperature |
| 310 | Line, Zr Deposition Rate, 400° C. |
| 312 | Line, Zr Resistivity, 400° C. |
| 400 | Graph |
| 402 | Line, Pure Zr |
| 404 | Line, Zr with 4% N₂, at Room Temperature |
| 406 | Line, Zr with 10% N₂, at Room Temperature |
| 408 | Line, Zr with 4% N₂, 400° C. |
| 410 | Line, Zr with 10% N₂, 400° C. |
| 500 | Graph |
| 502 | Line, Control Foil |
| 504 | Line, Asymmetric Membrane |
| 510 | Graph |
| 512 | Line, Control Foil |
| 514 | Point, Asymmetric Membrane |
| 516 | Point, Asymmetric Membrane |
| 518 | Point, Asymmetric Membrane |
| 520 | Line, Asymmetric Membrane |
| 600 | Graph |
| 602 | Line, 4% N₂, Room Temperature |
| 604 | Line, 10% N₂, Room Temperature |
| 606 | Line, 4% N₂, 400° C. |
| 608 | Line, 10% N₂, 400° C. |
| 610 | Point, 425° C. |
| 612 | Point, 450° C. |
| 614 | Point, 475° C. |
| 700 | Graph |
| 702 | Points, Unstable Symmetric Membrane |
| 704 | Points, Stable Symmetric Membrane, 4% N₂ |
| 706 | Points, Stable Symmetric Membrane, 10% N₂ |
| 708 | Line, Base Vanadium Foil |
| 710 | Line, Base Palladium Foil |
| 800 | Graph |
| 802 | Line, Symmetric Membrane |
| 810 | Graph |
| 812 | Line, Symmetric Membrane, As-Deposited |
| 814 | Line, Symmetric Membrane, Permeate |
| 816 | Line, Symmetric Membrane, Feed |
| 900 | Graph for As-Deposited Membrane |
| 902 | Line, Palladium |
| 904 | Line, Zirconium |
| 906 | Line, Nitrogen |
| 908 | Line, Vanadium |
| 910 | Line, Oxygen |
| 912 | Line, Hydrogen |
| 920 | Graph for Membrane Tested at 400° C. |
| 930 | Graph for Membrane Tested at 500° C. |
| 940 | Graph for Oxygen Traces |
| 942 | Line, As-Deposited Membrane |
| 944 | Line, 400° C. Tested Membrane |
| 946 | Line, 500° C. Tested Membrane |
| 1000 | Image, As-Deposited Membrane |
| 1002 | Image, 400° C. Tested Membrane |
| 1004 | Image, 500° C. Tested Membrane |
| 1006 | Platinum Group Metal (PGM) Layer |
| 1008 | Gradient Layer |

### DETAILED DESCRIPTION

Although the following text sets forth a detailed description of numerous different embodiments, it should be understood that the legal scope of the description is defined by the words of the claims set forth at the end of this disclosure. The Detailed Description is to be construed as exemplary only and does not describe every possible embodiment since describing every possible embodiment of the hydrogen-permeable, intermetallic diffusion barriers used in body-centered cubic (BCC) metal membranes (e.g., the composite membrane, for purposes of the present disclosure) would be impractical, if not impossible. Numerous alternative embodiments could be implemented, using either current technology or technology developed after the filing date of this patent, which would still fall within the scope of the claims. Additionally, any combination of features shown in the various figures can be used to create additional embodiments of the present disclosure. Thus, dimensions, aspects, and features of one embodiment of the composite membrane can be combined with dimensions, aspects, and features of another embodiment of the composite membrane to create the claimed embodiment.

High purity hydrogen is employed in several applications such as proton-exchange membrane (PEM) fuel cells, hydrocarbon processing, semiconductor processing, and nuclear fuel cycles. Known industrial hydrogen gas (H₂) purification methods such as pressure swing adsorption (PSA) and cryogenic distillation are energy intensive. For purposes of the present disclosure, high purity hydrogen is contemplated as (by way of non-limiting example) having a purity of at least about 90%, at least about 95%, at least about 99%, at least about 99.5%, at least about 99.9%, or at least about 99.99%, on a mass molar and/or volume basis.

Membrane-based purification methods utilizing membrane separations are a low-energy and cost-effective alternative for hydrogen purification compared to conventional techniques such as PSA or cryogenics. For example, dense metallic membranes represent a technology of interest for the separation of H₂ from other gases, due to their high permeability and potentially infinite H₂ selectivity. Membranes consisting of platinum group metals (PGMs) (e.g., palladium (Pd), palladium alloys, and the like) are known to be useful for this separation process, but the rising cost of PGM metals (and noble metals, in general) makes the use of palladium metallic membranes (or foils) cost-prohibitive in most applications.

Body centered cubic (BCC) group 5 metals (e.g., such as vanadium (V), niobium (Nb), and tantalum (Ta)) are neutron-tolerant materials that have potential for use in nuclear fuel cycles and other fusion applications, due to their favorable thermophysical and mechanical properties. In addition, group 5 metals have compatibility with tritium breeding materials and exhibit low levels of induced radioactivity when subjected to neutron irradiation.

In general, BCC group 5 metals have extraordinarily high hydrogen permeability. However, BCC metals lack the ability to catalyze hydrogen dissociation or re-combinative desorption, as BCC metals have an affinity for impurities (e.g., oxygen) that can impede H₂ transport. Thus, although BCC group 5 metals may provide a more cost-effective alternative for highly hydrogen-permeable membranes, BCC group 5 metals also require the use of a catalytic layer for H₂ dissociation and/or recombination.

Application of platinum group metal (PGM) catalysts (e.g., a platinum group metal such as palladium (Pd), platinum (Pt), ruthenium (Ru), or the like) provide catalytic layer functionality for H₂ dissociation and/or recombination. In particular, thin layers of palladium are known to enhance H₂ permeability. However, membranes with PGM catalysts are also known to fail due to intermetallic diffusion between the catalytic coating and base metal. For example, PGM catalysts undergo rapid interdiffusion with the BCC metals at elevated temperatures (e.g., temperatures greater than 300 degrees Celsius (° C.) (572 degrees Fahrenheit (° F.))) that leads to loss of performance. Although the temperature may be lowered to reduce intermetallic diffusion, hydrogen embrittlement at the reduced temperatures may lead to catastrophic failure. As such, it is contemplated there is a limited range of temperature and pressure within which stable operation of PGM catalysts is possible.

One alternative to PGM catalysts is the use of thin intermetallic diffusion barriers deposited between the BCC group 5 metal layer and a PGM layer or coating. The barriers may prevent intermetallic diffusion while allowing H₂ permeation. Monolayer graphene has been shown to hinder intermetallic diffusion between palladium and niobium foils for short time scales below 600° C. However, there is concern that these monolayers may break due to deformations at the niobium interface and/or due to the high mobility of palladium. Metal carbide layers (e.g., molybdenum carbide (Mo₂C)) have also been shown to provide catalytic activity at high temperatures, but long-term stability is compromised as known thermodynamic properties favor vanadium carbide (V₂C) formations that may inhibit H₂ transport. In addition, the effectiveness of carbides is believed to be attenuated during mixed gas testing with N₂ and CO₂ due to competitive adsorption, limiting their utility in practical applications unless the membranes are coated with palladium.

It is contemplated that carbides may have use as intermetallic diffusion barriers. For example, palladium-titanium carbide-vanadium (Pd—TiC—V) membranes are stable at 500° C., which is believed to be at least partially attributed to the stability from the lower energy of formation of TiC relative to V₂C. Similarly, niobium carbide (Nb₂C) may have use as a barrier in Nb—Pd composite membranes.

In addition, a class of high temperature intermetallic diffusion barriers of potential use include nitrides, or a metallic compound including nitrogen (N). Based on known thermodynamic properties, common elements that have an affinity for both nitrogen and oxygen include the group 4 metals (e.g., titanium (Ti), zirconium (Zr), hafnium (Hf), and the like). Notably, the group 4 metals may have a higher affinity for nitrogen and oxygen than group 5 metals. Thus, group 4 metal oxides and metal nitrides can serve as stable and protective coatings for group 5 metals (e.g., as an intermetallic diffusion barrier). For example, stable H₂ permeation for up to 35 hours has been observed at 600° C. using hafnium nitride (HfN) as an intermetallic diffusion barrier between tantalum (Ta) foils and palladium layers. However, it is noted that the effective permeability was attenuated significantly with the HfN diffusion barrier (e.g., an effective permeability of about 4×10⁻⁹ mol H₂ m m⁻² s⁻¹ Pa^{-0.5}) or approximately 4% of the permeability of the underlying tantalum foil), which is believed to be attributed to slow hydrogen diffusion through the HfN diffusion barrier.

Aspects of the present disclosure are thus directed to the use of thin, hydrogen-permeable, intermetallic diffusion barriers deposited between a BCC group 5 metal foil and a PGM catalyst that enables stable hydrogen permeation at temperatures up to at least about 450° C., and in many embodiments up to at least about 500° C. In particular, group 4 nitrides (e.g., such as zirconium nitride (ZrN), titanium nitride (TiN), HfN, and the like) are thermodynamically stable with respect to the BCC group 5 metals, and sufficiently thin layers (e.g., typically about 10 to about 100 nm, and most typically about 10 to about 50 nm) can be highly permeable to hydrogen while also serving as intermetallic interdiffusion barriers. In one particular example, Pd—ZrN—V—ZrN—Pd composite membranes may exhibit hydrogen selectivity and/or permeability up to four times (4×) greater than a PGM foil, such as a palladium foil.

In embodiments, a group 4 nitride, such as ZrN, is deposited via reactive sputtering techniques, which were characterized as thin films having a function of reactive sputtering conditions using X-ray diffraction (XRD), profilometry, and resistivity measurements. The hydrogen permeability of thin ZrN films made according to these embodiments was considered using Pd—ZrN—V—ZrN—Pd composites by measuring H₂ permeation, and performance was correlated to synthesis conditions. Further, optimization of ZrN was considered through experimentation by testing different sputter conditions to produce membranes with high permeability that prevent intermetallic diffusion and enhance thermal stability. For example, stability and degradation was assessed using composition depth profiling (e.g., time-of-flight secondary ion mass spectrometry (TOF-SIMS)) and transmission election microscopy (TEM). From this testing, long term stability (i.e., greater than 100 hours) was also demonstrated, making the membranes disclosed throughout the present disclosure a promising cost-effective alternative for hydrogen purification.

In this regard, aspects of the present disclosure are directed to thin films of group 4 nitrides (e.g., ZrN) or group 4 oxides that are effective hydrogen-permeable intermetallic diffusion barriers between BCC group 5 metals and PGM layers or coatings (e.g., Pd or the like). The films were used to produce composite membranes for high temperature H₂ purification with superior permeability compared to the known PGM foils (e.g., Pd foils). The thin films may be applied or deposited via techniques including reactive sputtering and/or atomic layer deposition.

In general, embodiments of the present disclosure are directed to hydrogen-permeable, intermetallic diffusion barriers used in body-centered cubic (BCC) metal membranes for use in hydrogen purification. Embodiments of the present disclosure are directed to a composite membrane having a BCC metal layer (e.g., selected from a group 5 BCC metal), one or more nitride layers (e.g., selected from group 4 nitrides), and one or more platinum group metal (PGM) layers or coatings. Particular embodiments of the present disclosure are directed to composite membranes whose layer stacking or configuration is symmetric. Particular embodiments of the present disclosure are also directed to composite membranes, and methods of manufacture thereof, in which one or more layers are applied and/or deposited via reactive sputtering.

Embodiments of the present disclosure are also directed to layer thicknesses of the composite membrane ranging from about 10 nm to about 100 nm. Embodiments of the present disclosure are also directed to operating temperatures ranging from approximately room temperature (e.g., about 15° C.) to about 500° C. without rapid interdiffusion of the layers. Embodiments of the present disclosure are also directed to operating times of the composite membrane up to at least about 200 hours of continuous operation.

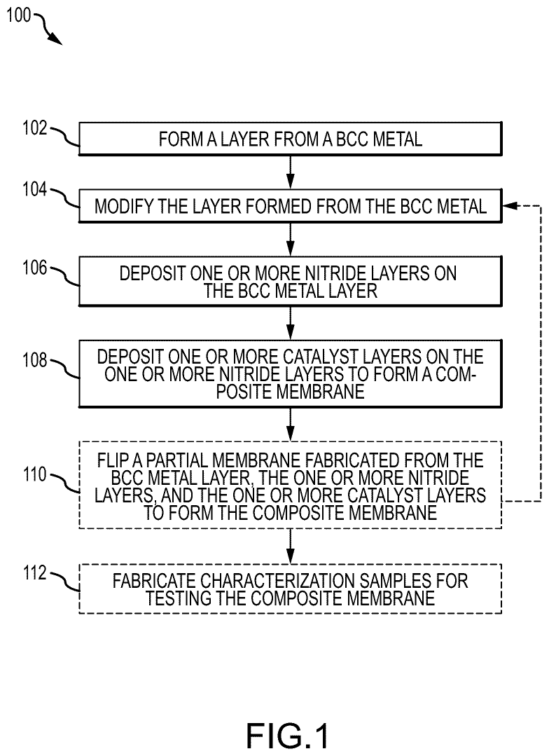

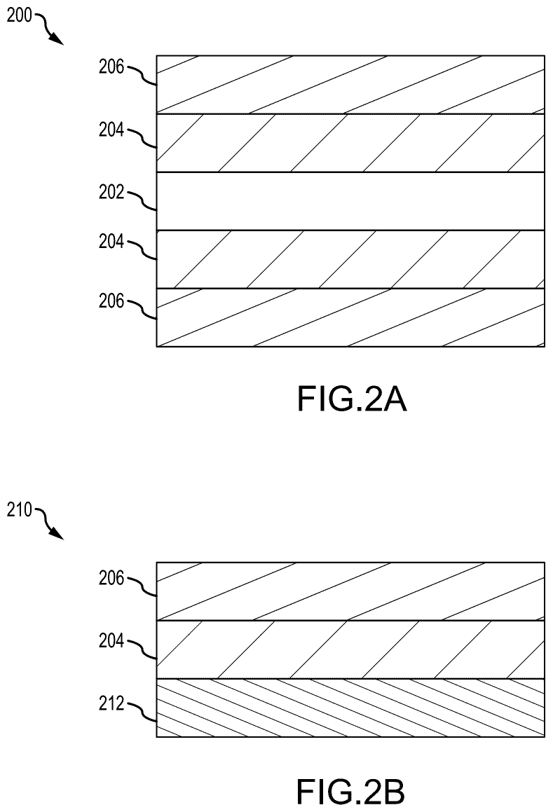

FIG. 1 is a method or process flow diagram 100 illustrating the process of fabricating or producing a membrane 200 as illustrated in FIG. 2A and/or a membrane 210 as illustrated in FIG. 2B, in accordance with one or more embodiments or the present disclosure. While a general order for the steps of the method or process is shown in FIG. 1, the method or process can include more or fewer steps or can arrange the order of the steps differently (including simultaneously, substantially simultaneously, or sequentially) than those shown in FIG. 1. It is noted that the method or process shall be explained with reference to the components, devices, subassemblies, environments, etc. described in conjunction with FIGS. 2A and 2B. For example, it is noted that the embodiments as illustrated in FIGS. 2A and 2B should be understood as reading on the embodiments described with respect to FIG. 1, and vice versa, without departing from the scope of the present disclosure.

In a step 102, a layer 202 of the membrane 200 is formed from a foil including a BCC metal. In embodiments, the BCC metal structure includes a group 5 metal. For example, the group 5 metal for the layer 202 may be selected from vanadium (V), niobium (Nb), tantalum (Ta), and combinations thereof. In some instances, the layer 202 may be formed from a cold-rolled foil of vanadium having a thickness of approximately 90 to 110 micrometers (μm), or approximately 100 μm, and having a purity of at least about 90%, at least about 95%, at least about 99%, at least about 99.5%, at least about 99.9%, or at least about 99.99%, on a mass molar and/or volume basis. For example, the cold-rolled foil of vanadium may have a purity of approximately 99.8%.

In a step 104, the layer 202 is modified. In some embodiments, the layer 202 may be modified using reactive sputtering. For example, the reactive sputtering may occur in a system that maintains a base pressure of less than 10⁻⁵ pascals (Pa). For instance, the system may be a multi-target magnetron sputtering system. In one non-limiting example, the layer 202 is subjected to a 30-minute argon sputter treatment by applying 50 watts (W) of radio frequency (RF) power to a susceptor at 0.67 Pa to remove native oxides present on one or more surfaces of the layer 202. In other embodiments, the layer 202 may be modified using atomic layer deposition.

In a step 106, one or more nitride layers 204 are deposited on the layer 202. In embodiments, the one or more layers 204 includes a group 4 nitride with a nitride ion (N³⁻) compounded with a group 4 metal. For example, the group 4 metal may be selected from titanium (Ti), zirconium (Zr), and hafnium (Hf), such that the group 4 nitride is TiN, ZrN, or HfN, respectively. The group 4 nitride may, by way of non-limiting example, be deposited onto the layer 202 by reactively sputtering through an application of 100 W of RF power to a zirconium target 2 inches in diameter in an ambient environment including nitrogen and argon (an N₂/Ar environment). In some non-limiting examples, the one or more nitride layers 204 are formed by depositing ZrN material on the layer 202 through reactive sputtering.

In a step 108, one or more catalyst layers 206 are deposited on the layer(s) 204 of group 4 nitride. In embodiments, without breaking vacuum, a platinum group metal (PGM) is deposited as the material of layers 206 on the layers 204 of the group 4 nitride. For example, the PGM may include, but is not limited to, palladium (Pd). In some instances, palladium layers 206 may be deposited onto ZrN layers 204. The PGM may, by way of non-limiting example, be deposited using direct current sputtering with 165 milliamps (mA) of current applied to a palladium target 2 inches in diameter.

In some embodiments, following the performing of steps 102, 104, the membrane 200 is completed with per-side processes 106, 108 to form a symmetric composite membrane 200 having a first layer 206, a second layer 204, a third layer 202, a fourth layer 204, and a fifth layer 206.

In one non-limiting example, steps 102, 104 are performed to form and clean the layer 202 including the group 5 metal. Steps 106, 108 may each occur a first time to first deposit a first group 4 nitride layer 204 and then a first PGM layer 206 on a first side of the group 5 metal layer 202, to form a partial membrane. An optional step 110 to flip the partial membrane may then be performed, and steps 106, 108 may each then be performed a second time to deposit a second group 4 nitride layer 204 and then a second PGM layer 206 on a second side of the group 5 layer 202. This results in the symmetric configuration of layers for the composite membrane 200.

In another non-limiting example, the layer (or layers) 204 including the group 4 nitride is deposited onto both (or multiple) sides of the layer 202 including the group 5 metal. The layer (or layers) 206 including a PGM is then deposited on the layer (or layers) 204 including the group 4 nitride to create the symmetric configuration of layers for the composite membrane 200, such that no flipping of a partial membrane is necessary.

In an optional step 112, characterization samples are fabricated to test the composite membrane. In embodiments, a characterization sample includes an asymmetric membrane 210. The asymmetric membrane 210 includes a layer 212 (e.g., including, but not limited to, a PdCu layer), on which a layer 204 and then a layer 206 (as described with respect to the membrane 200) are deposited. For example, the layer 212 may be formed from a Pd₆₀Cu₄₀ wt % alloy that has a thickness of about 25 μm.

To characterize the hydrogen permeability of the group 4 nitride (e.g., the ZrN) thin film, characterization (or witness) samples may be formed using glass substrates with thin films of the group 4 nitride (e.g., the ZrN) and subsequent films of PGM (e.g., 100 nm thickness Pd films). For example, the layers 204 of the group 4 nitride and the PGM may be applied (e.g., reactive sputtered) onto sputter-cleaned PdCu foils using the conditions used for membrane 200 fabrication, as described with respect to FIG. 1 and the steps 102, 104, 106, 108, (110) of process 100. For instance, the glass substrates may include, but are not limited to, silicon (Si) wafers. Optionally, the asymmetric membranes 210 may be mounted with a tritium generation or recovery system such that the layer 202 faces a feed side (or high pressure side) of the system, while the layer 212 faces a permeate side of the system.

In this regard, deposition rates of the PGM (e.g., Pd) onto the group 4 nitride layers 204 may be measured and/or controlled using the comparative asymmetric membranes 210 and by measuring a thickness (e.g., using profilometry). In some examples, a palladium deposition rate is approximately 6 nanometers per min (nm/min), and the thickness of the PGM layers 206 is set or fixed at approximately 100 nm.

In embodiments, a crystal structure of the symmetric membrane 200 may be evaluated following fabrication. In some embodiments, the crystal structure is optionally evaluated using X-ray diffraction (XRD) with x-ray energy such as Copper K-alpha (Cu K-α) radiation with a wavelength of 0.15406 nm. In additional embodiments, the membrane 200 may be probed to determine a resistivity of using the characterization (i.e., witness) samples deposited on glass substrates. In further embodiments, Time of Flight Secondary Ion Mass Spectrometry (TOF-SIMS) is used to obtain depth profiles from membranes before and after testing. For example, the TOF-SIMS procedure may use a primary ion beam produced from a three-lens bismuth-manganese (BiMn) cluster ion gun with an energy of 30 kiloelectronvolts (keV). It is noted that a secondary ion beam used for sputtering may optionally utilize a thermal ionization cesium source and oxygen electron impact gas ion source. In further embodiments, samples for transmission electron microscopy (TEM) may optionally be prepared with optional focus ion beam milling and imaging.

In embodiments, hydrogen permeation measurements may be taken by sealing a symmetric membrane 200 (e.g., including Pd—ZrN—V—ZrN—Pd layers) and an asymmetric membrane 210 as illustrated in FIG. 2B (e.g., including Pd—ZrN—PdCu) into a cell. For example, the cell may have an effective surface area of about 0.93 centimeters squared (cm⁻²).

In embodiments, the membranes 200, 210 may be heated under atmospheric ultra-high purity helium (UHP He) flow in a furnace to desired testing temperatures (e.g., about 400 to about 600° C.). For purposes of the present disclosure, UHP He is contemplated as (by way of non-limiting example) having a purity of at least about 90%, at least about 95%, at least about 99%, at least about 99.5%, at least about 99.9%, or at least about 99.99%, on a mass molar and/or volume basis.

After heating to a low end of the desired testing temperatures (e.g., approximately 400° C.), the membranes 200, 210 optionally undergo an air oxidation treatment. For example, the air oxidation treatment may include 1 minute of air exposure followed by flushing with UHP He to fully activate the layer 206. Subsequently, the membranes 200, 210 may be exposed to ultra-high purity hydrogen gas (UHP H₂) before increasing the furnace to operating pressures. For example, the membranes 200, 210 may be exposed to UHP H₂ for 5 minutes. For purposes of the present disclosure, UHP H₂ is contemplated as (by way of non-limiting example) having a purity of at least about 90%, at least about 95%, at least about 99%, at least about 99.5%, at least about 99.9%, or at least about 99.99%, on a mass molar and/or volume basis.

During exposure, feed, sweep, and permeate gases may be controlled by mass flow controllers (MFC) calibrated with a soap bubble flow meter. For example, the feed side may be supplied with a constant H₂ flow rate of 100 standard cubic centimeters per minute (sccm) under variable pressure of about 130 to about 500 kilopascals (kPa) regulated by a back pressure regulator in a retentate line. The permeate may be collected at ambient pressure, and the membranes 200, 210 may be periodically exposed to UHP He to ensure no leaks and confirm the infinite H₂ selectivity of the membranes 200, 210.

Referring now to Eq. 1, the H₂ permeability a of the membranes 200, 210 may be determined from the measured H₂ flux (J) and upstream pressure (P_{F}), where (P_{P}) is the permeate pressure and (L) is the membrane thickness, based on Sieverts' law (e.g., with n=0.5). The use of n=0.5 assumes that permeation is limited by bulk diffusion, which may be enabled through the application of Pd that provides rapid reaction at the surfaces.

$$π = \frac{J \times L}{( {P}_{F}^{0.5} - {P}_{P}^{0.5} )} \qquad Eq . 1$$

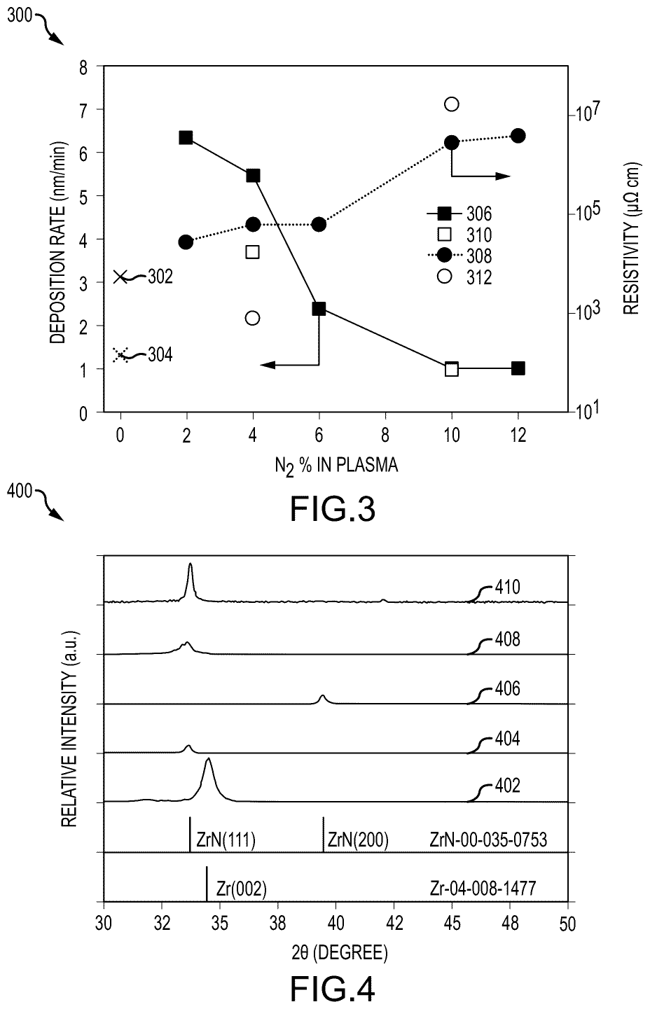

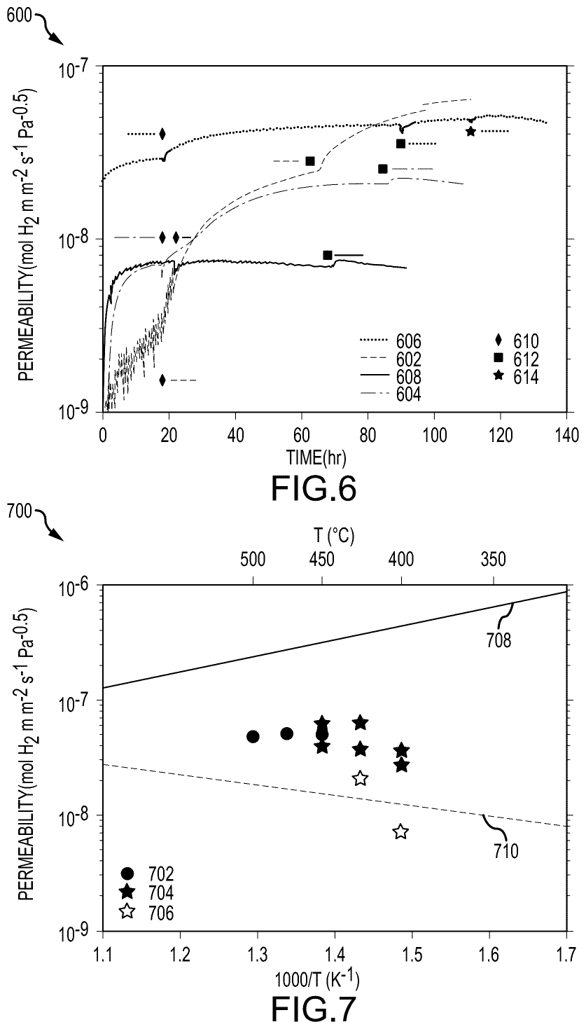

FIGS. 3-10 illustrate the analysis of the membranes 200, 210 formed via the process 100. In particular, the properties and performance of the group 4 nitride (e.g., the ZrN) was considered as a function of percentage N₂ by volume (% N₂ by volume, or vol % N₂), substrate temperature, and film thickness. It is noted that FIGS. 3 to 5B focus on the asymmetric membrane 210, and that FIGS. 6 to 10 focus on the symmetric membrane 200.

Referring now to FIG. 3, a graph 300 illustrates deposition rate (in nanometers per minute, or nm/min) and volume or bulk resistivity (in microohm-centimeters (μΩ cm)) versus nitrogen (N₂) partial pressure in plasma, for the membrane 210 at room temperature (RT). In the graph 300, the Xs represent metallic or pure Zr at 0% N₂ by volume for deposition and resistivity, with a solid X 302 representing deposition rate and a broken-line X 304 representing resistivity for the metallic or pure Zr at 0% N₂. In addition, line 306 represents deposition rate at RT, line 308 represents resistivity at RT, open squares 310 represent deposition rate at an increased temperature (e.g., 400° C.), and open circles 312 represent resistivity at the increased temperature. It is noted that the lower deposition rate observed in FIG. 3 reflects differences in density between materials.

With the addition of N₂, the graph 300 illustrates a sigmoidal shape characteristic of reactive sputtering. At low levels of N₂ (e.g., less than or equal to approximately 4% N₂ by volume) the zirconium target surface remains predominantly metallic (i.e., is a metallic regime), leading to high rates and low resistivity due to the presence of N vacancies and defects in the deposited films. Conversely, a compound regime is observed at sufficiently high N₂ partial pressure (e.g., greater than or equal to 10% N₂ by volume) where the target surface is largely nitride, deposition rates are low and stable, and films exhibit high resistivity. This increased resistivity can be attributed to the presence of a more stoichiometric ZrN with fewer defects.

It is noted that substrate temperature had an impact on resistivity, but was dependent on the deposition regime, i.e., the composition of the atmosphere in which sputtering was carried out. For example, in the metallic regime (e.g., in atmospheres containing no more than about 4% N₂), deposition at 400° C. lowered the rate by ˜30% and reduced the resistivity two orders of magnitude relative to RT. Conversely, high temperature deposition in the compound regime (e.g., in atmospheres containing at least about 10% N₂) at 400° C. resulted in nominally identical rates and exhibited a higher resistivity compared to RT. From this, it is understood that elevated substrate temperature promotes nitrogen incorporation in the compound regime, but limits it in the metallic regime. As discussed further herein, resistivity is a beneficial metric that is correlated to membrane performance. As illustrated in FIG. 3, the two regimes (e.g., atmospheres containing no more than about 4% N₂, and at least about 10% N₂, respectively) are bridged by a transition regime where the rate falls and resistivity climbs.

Referring now to FIG. 4, a graph 400 illustrates relative intensity (in arbitrary units, or a.u.) versus the 20 angle (i.e., between transmitted beam and reflected beam), for ZrN deposited at room temperature (RT) and at 400° C. as a function of nitrogen (N₂) partial pressure. The graph 400 illustrates the XRD patterns of thin films that are 100 nm thick deposited on Si wafers under various conditions. In particular, line 402 represents metallic or pure Zr, line 404 represents the compound regime (e.g., greater than or equal to 10% N₂) at RT, line 406 represents the compound regime (e.g., greater than or equal to 10% N₂) at 400° C., line 408 represents the metallic regime (e.g., less than or equal to 4% N₂) at RT, and line 410 represents the compound regime (e.g., less than or equal to 4% N₂) at 400° C.

When no N₂ gas is used during deposition at line 402, the primary peak observed was Zr (002) reflection at 2θ=34.4°. However, with the addition of 4% N₂ gas, the primary peak of lines 408 and 410 shifts to ZrN (111) at 20=33.7°, with no evidence of metallic Zr remaining. The peak intensity and sharpness are both increased when the deposition is carried out at 400° C., consistent with better crystallinity and the formation of larger grains. In addition, films deposited with 10% N₂ at RT of line 404 displayed similar crystallinity to that of 4% N₂. However, deposition at 400° C. with 10% N₂ of line 406 resulted in ZrN with a preferential orientation to ZrN (200) at 2θ=39.4°. This change in orientation is believed to contribute to the elevated resistivity illustrated in FIG. 3.

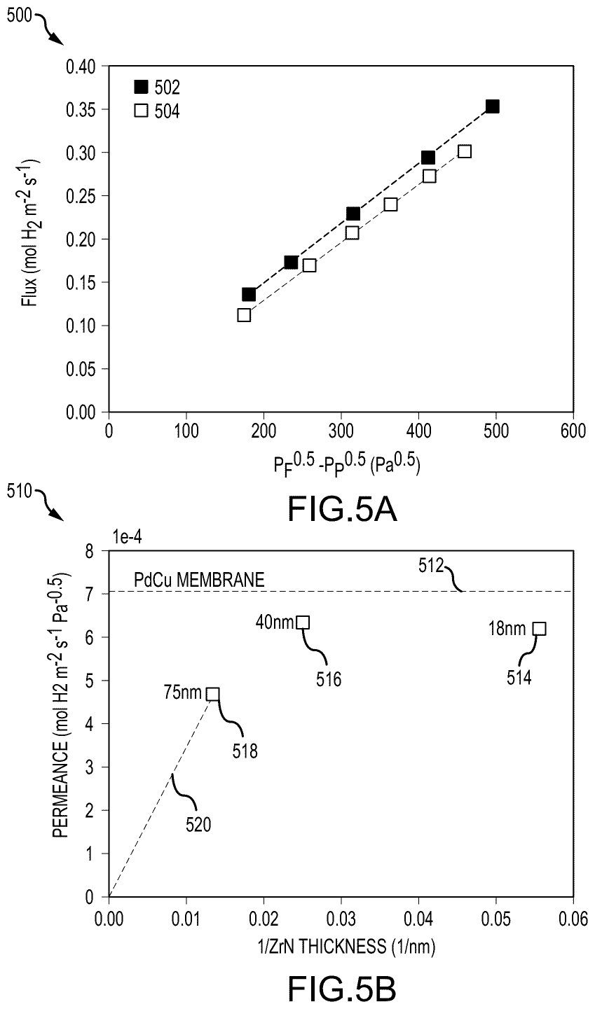

Referring now to FIGS. 5A and 5B, to quantify the hydrogen permeability of ZrN thin films, the asymmetric membrane 210 (e.g., Pd—ZrN—PdCu) was used. For example, the asymmetric membrane 210 was fabricated by sputtering ZrN (e.g., 10-100 nm) and Pd (100 nm) to create the layers 204 and 206, respectively, onto sputter-cleaned 25-micron PdCu foil. It is contemplated that the Pd-based sandwich of the asymmetric membrane 210 ensured that H₂ dissociation/recombination were not limiting. Differences in permeance between the sandwich and a base or control PdCu foil are indicative of resistance introduced by the ZrN layer. It is noted that the ZrN layers in the asymmetric membrane 210 evaluated, as with the data shown in graph 500 of FIG. 5A and graph 510 of FIG. 5B, were deposited at 400° C. in the metallic regime (e.g., less than or equal to 4% N₂).

In particular, FIG. 5A is a graph 500 which compares the H₂ flux (in mol H₂ m⁻² s⁻¹) versus driving force (in P_{F}^{0.5}-P_{P}^{0.5} (Pa^{0.5})) for a control PdCu foil represented by line 502 and the asymmetric membrane 210 (e.g., a Pd—ZrN—PdCu composite) represented by line 504. The ZrN layer in the asymmetric membrane 210 was 40 nm in thickness and deposited at 400° C. using a 4% N₂ ambient. Both the control foil and the asymmetric membrane 210 display linear behavior when plotted against the square root driving force, which illustrates that H₂ flux is not limited by the surface but rather by diffusion limitations (i.e., as shown in Eq. 1, above).

In addition, FIG. 5B is a graph 510 that plots the H₂ permeance (in mol H₂ m⁻² s⁻¹ Pa^{-0.5}) versus the inverse of the ZrN thickness (in 1/nm). As illustrated in FIG. 5B, line 512 represents the control foil, and points 514/516/518, and line 520 represent the asymmetric membrane 210. The permeance of the asymmetric membrane 210 is constant at a value that is ˜10% lower than the base PdCu foil up to a thickness of approximately 40 nm (i.e., line 512 versus points 514 at 18 nm and point 516 at 40 nm). This 10% drop is attributed to interfacial resistances introduced by the sandwich structure. Further increasing the ZrN of the asymmetric membrane 210 (i.e., point 518 at 75 nm and line 520) leads to a decrease in permeance consistent with H transport through ZrN becoming the rate limiting step.

In embodiments, one estimate of the thin film ZrN permeability may be obtained from the linear extrapolation to the origin, which in this case yields a value of 3.7×10¹¹ mol H₂ m m⁻² s⁻¹ Pa^{-0.5}. This value is orders of magnitude greater than previous studies, including those where ZrN has been explored as a barrier to hydrogen transport with permeability being as low as 7.9×10¹¹ mol H₂ m m⁻² s⁻¹ Pa^{-0.5}. However, it is noted that the thickness of the films used in barrier applications are on the order of micrometers, which is one to two orders of magnitude greater than the thickness of the control film and asymmetric membrane 210 tested in FIGS. 5A and 5B. Thus, the films used in barrier applications are expected to have properties closer to bulk ZrN. The barrier studies also do not use a Pd layer for H₂ dissociation/recombination. As such, the low effective permeability reported in those studies is understood to be more a reflection of surface dissociation limitations than bulk permeability.

Based on the results illustrated in FIGS. 5A and 5B with the control foil and the asymmetric membrane 210, ZrN barriers with thicknesses of between approximately 20 and 40 nm were employed in the composite membranes (i.e., such as the asymmetric membrane 200) discussed herein. Thus, with the ZrN thickness of a membrane of about 20 to about 40 nm, reactive sputtering conditions were selected based on performance at temperatures ranging from about 400 to about 475° C. From this, a 2×2 matrix consisting of ZrN films deposited in the metallic regime (e.g., less than or equal to 4%) and compound regime (e.g., greater than or equal to 10%) at both room temperature and 400° C. was selected.

Referring now to FIG. 6, a graph 600 illustrates the transient behavior of four symmetric membranes 200 (e.g., comprising layers 202, 204, 206 forming a Pd—ZrN—V—ZrN—Pd stack) during long term testing, as a function of permeability (in mol H₂ m⁻² s⁻¹ Pa^{-0.5}) versus time (in hours). In FIG. 6, line 602 represents 4% N₂ at RT, line 604 represents 10% N₂ at RT, line 606 represents 4% N₂ at 400° C., line 608 represents 10% N₂ at 400° C., the diamond shape 610 represents 425° C. for respective membranes, the rectangle shape 612 represents 450° C. for respective membranes, and the star shape 614 represents 475° C. for respective membranes.

Testing began at T=400° C. and the temperature was increased in 25° C. increments at the times denoted in the graph 600. A common characteristic of the membranes 200 is that the initial permeability is relatively low (e.g., approximately 10⁻⁹ mol H₂ m m⁻¹ s⁻¹ Pa^{-0.5}). In addition, the membranes 200 can take a long time (e.g., 10 to 20 hours) to approach steady state. From graph 600, it is understood that films or membranes 200 at 400° C. (e.g., represented by lines 606, 608) reached steady state significantly more quickly than their RT counterparts (e.g., represented by lines 602, 604). This illustrates that higher crystallinity is beneficial, and that part of the transient with RT films is due to crystallization that appears to occur during high temperature testing. In addition, from the graph 600, a second observation is that higher permeability and better stability were obtained with films deposited in the metallic regime (e.g., less than or equal to 4% N₂). In particular, the permeability was 2-5 times greater for films deposited at 4% N₂ compared to 10% N₂. Likewise, the films deposited at 4% N₂ had better stability, showing no degradation up to 450° C. In contrast, films deposited at 10% N₂ were observed to decline when the temperature was raised to 425° C. This illustrates that N vacancies may be beneficial for both permeance and stability, according to the additional discussion provided herein.

Referring now to FIG. 7, the performance of various composite membranes 200 (e.g., comprising layers 202, 204, 206 forming a Pd—ZrN—V—ZrN—Pd stack) are illustrated in a graph 700 representing an Arrhenius plot, as a function of permeability (in mol H₂ m m⁻² s⁻¹ Pa^{-0.5}) versus T (in ° C.) or 1000/T (in Kelvin⁻¹ (K⁻¹)). In particular, a circle shape 702 represents a membrane 200 having unstable permeability, a solid star shape 704 represents a membrane 200 having stable permeability and with ZrN deposited at 4% N₂, and an open star shape 706 represents a membrane 200 having stable permeability and with ZrN deposited at 10% N₂. A solid line 708 is provided to represent a theoretical permeability for a base vanadium foil, and a broken line 710 is provided to represent a theoretical permeability for a base palladium foil.

The membranes 200 represented by the shapes 702, 704, 706 each displayed a minimum of 20 hours of stable operation at temperature. The membranes 200 represented by the shapes 702, 704, 706 include variations in ZrN thickness (e.g., ranging from about 20 to about 40 nm) and sputter conditions (e.g., in terms of temperature and/or % N₂).

As illustrated in the graph 700, the membranes 200 represented by the shapes 702, 704, 706 fabricated with ZrN sputtered in the metallic regime (e.g., less than or equal to 4% N₂) fall within a relatively narrow band of 4±2×10⁻⁸ H₂ m⁻¹ s⁻¹ Pa^{-0.5}). The introduction of ZrN reduces permeability relative to the base vanadium foil represented by line 708 by two-thirds to four-fifths. In contrast, ZrN sputtered in the compound regime (e.g., greater than or equal to 10% N₂) had permeability comparable to palladium (e.g., approximately 10⁻⁸ H₂ m⁻¹ s⁻¹ Pa^{-0.5}), as represented by the line 710 for the theoretical base palladium foil.

As shown in the Pd-based asymmetric membranes 210 illustrated in the graphs 500, 510 of FIGS. 5A and 5B, respectively, the Pd—ZrN interface has a minimal impact. As such, the majority of the permeability drop in FIG. 7 is believed to be attributable to resistance at the ZrN—V interface, as discussed herein. However, the ZrN imparts stability at a permeability level that is up to about 3 times greater than Pd while reducing the Pd inventory at least 99% relative to a 25 μm free-standing Pd foil.

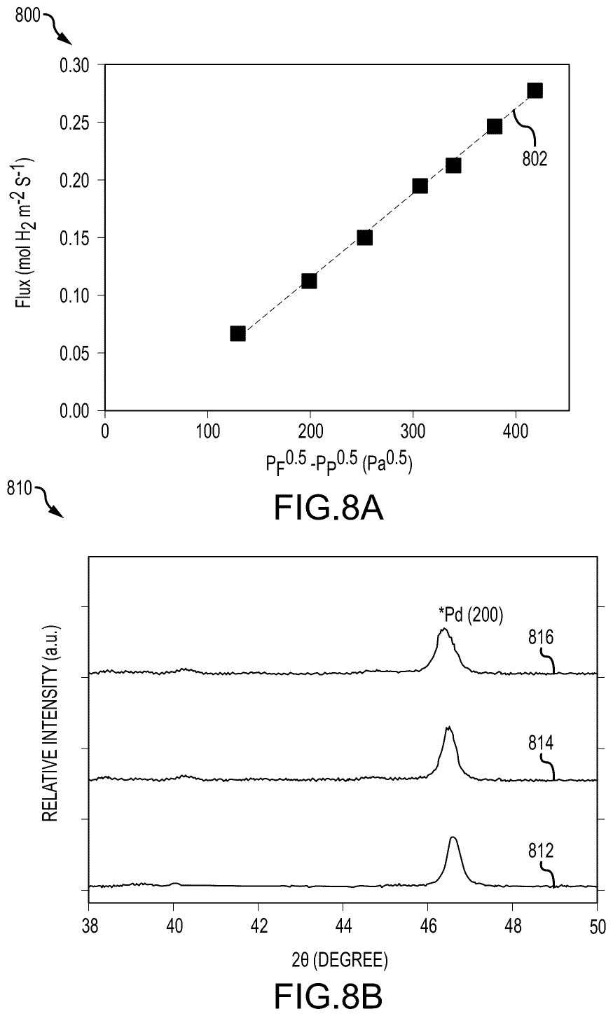

Referring now to FIGS. 8A and 8B, most composite membranes 200 tested were stable up to 450° C.

In particular, FIG. 8A is a graph 800 illustrating the performance of a composite membrane 200 represented by line 802, where the membrane 200 operated for at least 200 hours at T=425° C., as a function of H₂ flux (in mol H₂ m⁻² s⁻¹) versus driving force (in P_{F}^{0.5}-P_{P}^{0.5} (Pa^{0.5})).

In addition, FIG. 8B is a graph 810 illustrating XRD patterns before and after the 200-hour operating window as a function of relative intensity (in arbitrary units, or a.u.) versus the 2θ angle (i.e., between transmitted beam and reflected beam), at T=400° C. at 4% N₂. Line 812 represents the Pd layers as deposited, line 814 represents a permeate side, and line 816 represents a feed side.

The thickness of the membrane 200 tested in FIGS. 8A and 8B was 20 nm and was sputtered (in some instances) at a preferable combination of 4% N₂ and Ts=400° C. The membrane 200 obeyed Sievert's law (e.g., Eq. 1) throughout the long-duration operation and the Pd layers were nominally unchanged during the long-duration operation, as measured by XRD, with the primary peak of lines 812, 814, 816 being at approximately Pd (200) or 2θ=46.5°. It is noted that Pd—V interdiffusion is rapid without a ZrN barrier therebetween, leading to the loss of the Pd peak and the formation of PdV_{X} alloys. In addition, it is noted that membranes 200 fail rapidly when the temperature is raised to 500° C. This is expected from known thermodynamic properties, as this is the approximate temperature where ZrN begins to decompose into ZrN_{y}+N₂.

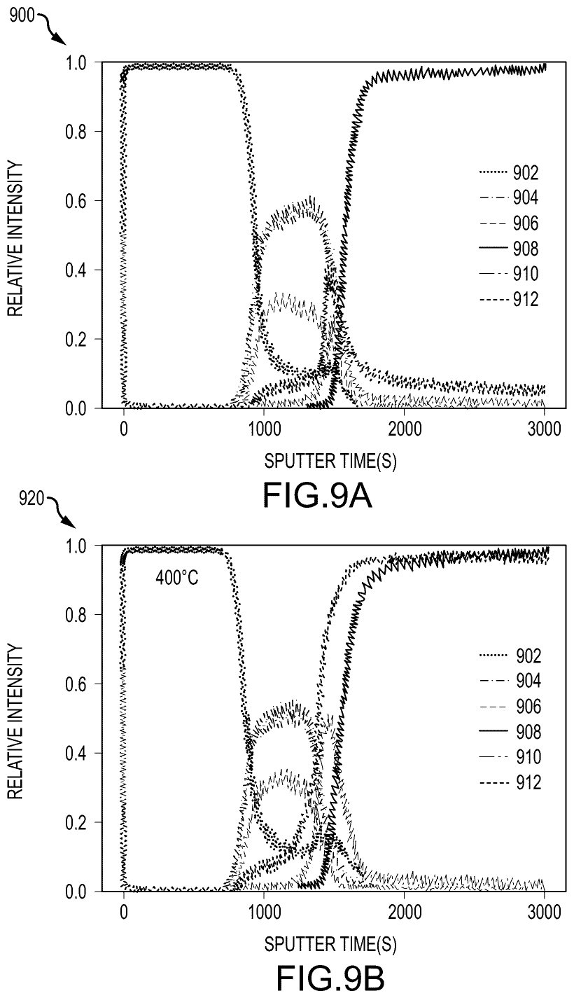

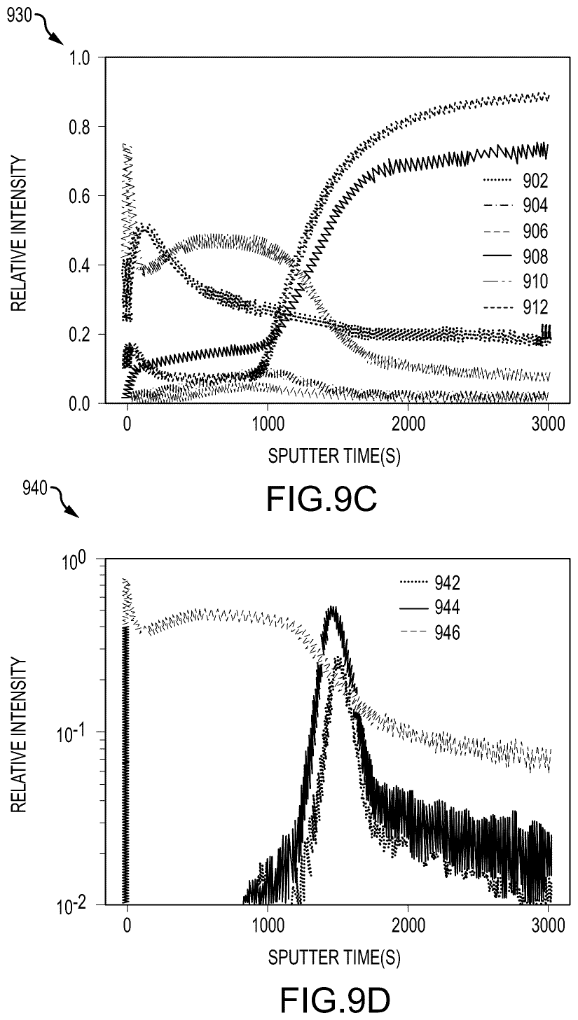

Referring now to FIGS. 9A-9D, TOF-SIMS depth profiling was used to illustrate the performance and stability of the composition, structure, and changes imparted during operation of the symmetric membrane 200. In particular, FIGS. 9A-9D compare composite membranes 200 with 40 nm ZrN layers 204 that, in some instances, are deposited at a preferable 400° C. and at 4% N₂. In FIGS. 9A-9C, the membranes 200 are illustrated as initially fabricated, and after testing for approximately 15 hours at both T=400° C. and T=500° C., respectively. It is noted that the membrane 200 at T=400° C. was stable over 15 hours with permeability greater than 2×10⁻⁸ H₂ m⁻² s⁻¹ Pa^{-0.5}, while the membrane 200 at T=500° C. rapidly degraded from an initial permeability of greater than 10⁻⁸ to less than 5×10⁻¹⁰ H₂ m⁻¹ s⁻¹ Pa^{-0.5} over 15 hours.

In FIGS. 9A-9D, the relative intensity obtained from TOF-SIMS as a function of sputtering time (depth) (in seconds (s)) is illustrated in graphs 900, 920, 930, 940 respectively for a composite membrane 200 including layers 202, 204, 206 (e.g., a PD-ZrN—V—ZrN—Pd membrane). In graphs 900, 920, 930, line 902 represents palladium, line 904 represents zirconium, line 906 represents nitrogen, line 908 represents vanadium, line 910 represents oxygen, and line 912 represents hydrogen.

The TOF-SIMS data was normalized among the heavy elements (e.g., Pd, Zr, N, V, and O), as provided in Eq. 2:

$${RI}_{i} = \frac{{I}_{i}}{\sum {I}_{Pd} + {I}_{Zr} + {I}_{V} + {I}_{N} + {I}_{O}} \qquad Eq . 2$$

In Eq. 2, RIᵢ and Iᵢ are the relative and absolute intensity of the element of interest, respectively. It is noted that hydrogen was excluded due to preferential sensitivity of TOF-SIMS to electropositive species, with cesium hydride (CsH⁺) signal being the dominant signal observed.

However, the relative hydrogen signal RI_{H} could be determined in an analogous manner including the H signal, as provided in Eq. 3:

$${RI}_{H} = \frac{{I}_{H}}{\sum {I}_{Pd} + {I}_{Zr} + {I}_{V} + {I}_{N} + {I}_{O} + {I}_{H}} \qquad Eq . 3$$

Referring now to FIG. 9A, graph 900 illustrates the relative intensity versus sputter time for a membrane 200 as-deposited (or as-fabricated). Three well-defined layers 202 (e.g., V), 204 (e.g., ZrN), and 206 (e.g., Pd) are observed in graph 900. Neglecting surface contamination, the Pd layer is essentially free of impurities. The ZrN layer is well defined, with a difference in the strength of the two signals not reflecting stoichiometry but instead instrument sensitivity. It should be understood that the Pd signal within the ZrN signal is an artifact of the sputter process. It is noted that, despite the use of a 30-minute sputter pre-clean, there is significant oxygen accumulation at the ZrN—V interface. While small, the O signal in the bulk V is significant relative to both the Pd and ZrN layers. Additionally, there is significant H signal throughout the ZrN layer and, like oxygen, the H intensity is maximized at the V interface and it persists throughout the V layer.

Referring now to FIG. 9B, graph 920 illustrates the relative intensity versus sputter time for a membrane 200 after testing for over 15 hours of H₂ permeation at T=400° C. The profiles are nominally identical to the membrane 200 as-fabricated, with the exception of the H signal being present in V at high concentration. It is noted that this indicates both the Pd and ZrN layers remained intact, with negligible Pd—V interdiffusion. In addition, it is noted that there is negligible H present in the Pd layer, despite the high solubility of the Pd layer. It is contemplated that the hydrogen naturally partitions to the V foil, due to the even higher solubility of the V foil. Alternatively, it is contemplated there was H present in Pd during testing, which desorbed while the membrane was cooled under the UHP He flow used during testing.

Further, it is noted that there is additional oxygen accumulation at the ZrN—V interface, for which the V foil is a potential source as it is known that BCC metals have high oxygen solubility relative to other metals and because oxygen segregates to the surface according to the Langmuir-McLean equation at high temperatures. As noted above, resistance at the ZrN—V interface is the primary reason for the lower permeability of the composite membranes 200 relative to V, and the observed oxygen accumulation is likely a prime contributor.

It should be understood from FIG. 6 that the membrane 200 performance is actually improving while O is accumulating at the ZrN—V interface, and the long-term transients are attributed to interactions of this interfacial O with permeating H. It is contemplated that this oxygen may play a role in the observed dependence on sputter conditions.

In addition, it should be understood that the ZrN deposited in the metallic regime (e.g., less than or equal to 4% N₂) is expected to have more N vacancies, as evidenced by its lower film resistivity as illustrated in FIG. 3. It is contemplated that such defects would be expected to getter oxygen or potentially lead to the formation of oxynitrides (e.g., such as ZrOₓN_{y}), and these interactions may be a contributor to a potentially higher permeability observed from ZrN deposited in the metallic regime (e.g., less than or equal to 4% N₂), as illustrated in FIGS. 6 and 7.

Referring now to FIG. 9C and the relative intensity versus sputter time for a membrane 200 after testing for over 15 hours at T=500° C., graph 930 illustrates that the ZrN is decomposed after testing at 500° C., which is consistent with known thermodynamic properties. For example, significant loss observed of both constituent elements may be due to rapid interdiffusion (e.g., for the Zr) and/or volatilization (e.g., for the N). For instance, intermetallic diffusion between Pd and V is rapid without the presence of ZrN, with extensive penetration of Pd into the V foil. In addition, loss of ZrN at 500° C. leads to substantial oxidation, with both V and the released Zr being excellent oxygen getters. Further, the hydrogen profile tracks V and extends to the surface in the absence of an interdiffusion barrier.

Referring now to FIG. 9D and the relative intensity versus sputter time for a membrane 200, graph 940 illustrates oxygen traces from the three samples. In particular, line 942 represents the membrane 200 as-deposited (or as-fabricated) from FIG. 9A, graph 900. In addition, line 944 represents the membrane 200 after 15 hours at T=400° C. from FIG. 9B, graph 920. Further, line 946 represents the membrane 200 after 15 hours at T=500° C. from FIG. 9C, graph 930. It is noted that the relative intensity is illustrated on a semi-logarithmic scale in FIG. 9D, graph 940.

Graph 940 illustrates the accumulation of O at the ZrN—V interface that occurred during testing at 400° C. (e.g., FIG. 9B, graph 920). With the exception of adventitious surface contamination, the O signal is negligible in the Pd film, illustrating that the source of the O is the V foil itself. Oxygen migration from the bulk to this interface during testing is thus apparent, and the long transients are again attributed to the phenomenon of the V foil being the source of the oxygen.

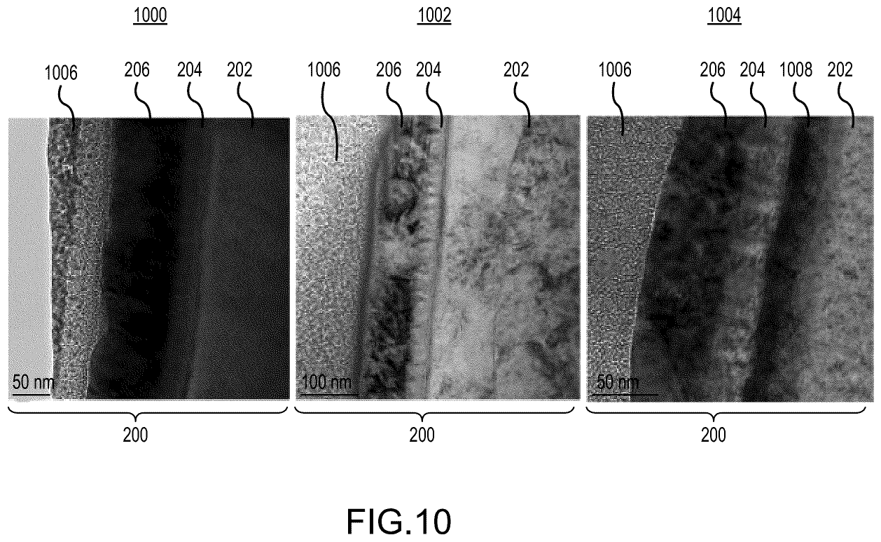

Referring now to FIG. 10, TEM images 1000, 1002, 1004 are provided to corroborate the TOF-SIMS observations of the samples used to obtain the data illustrated in FIGS. 9A-9D. The TEM images 1000, 1002, 1004 illustrate a composite membrane 200 including a layer 202 (e.g., a V layer), a layer 204 (e.g., a ZrN layer), and a layer 206 (e.g., a Pd layer). Although not shown, it should be understood that the composite membrane 200 in TEM images 1000, 1002, 1004 is symmetric with additional mirrored layers 204 and 206. In addition, it should be understood that a platinum (Pt) layer 1006 is illustrated solely as a feature of a focused-ion beam (FIB) sample operation.

In particular, image 1000 is the as-deposited (or as-fabricated) membrane 200 for which data are provided in FIG. 9A, graph 900. The three layers 202, 204, 206 of the membrane 200 are well-defined in the image 1000, with individual thicknesses for each of the layers 202, 204, 206 being illustrative to the control and accuracy possible with calibrated sputter rates.

In addition, image 1002 is the membrane 200 at T=400° C. for 15 hours and for which data are provided in FIG. 9B, graph 920. The three layers 202, 204, 206 of the membrane 200 still retain sharp interfaces in the image 1002 after the testing for 15 hours at T=400° C., though a slight contraction may have occurred in at least layers 204 and 206. It is contemplated that the slight contraction may reflect densification of the films that occurs during extended high temperature testing.

Further, image 1004 is the membrane 200 at T=500° C. for 15 hours and for which data are provided in FIG. 9C, graph 930. The three layers 202, 204, 206 of the membrane 200 are largely disrupted in the image 1004 after the testing for 15 hours at T=500° C., which corroborates the data obtained using TOF-SIMS. It is noted that the thickness of the layer 206 (e.g., attributed to Pd) has been reduced considerably as compared to the layer 206 illustrated in image 1000 due to extensive interdiffusion. In addition, the thickness of the layer 204 (e.g., attributed to ZrN) has been reduced and is significantly disrupted. Further, image 1004 shows there is no longer a distinct interface with V, but instead there is an additional gradient layer 1008 between ZrN and V. In some embodiments, it is contemplated the gradient layer 1008 is Pd accumulation in the V.

From the foregoing, the present disclosure illustrates that reactively sputtered group 4 nitride (e.g., ZrN) thin films are effective hydrogen-permeable intermetallic diffusion barriers between group 5 foils (e.g., V) and a PGM (e.g., Pd), for the production and fabrication of composite membranes for high temperature H₂ purification, with superior permeability to known Pd foils. To illustrate this, reactive sputtering processes were characterized with respect to rate and properties during testing, as described in the present disclosure, and performance of ZrN produced in the metallic regime (e.g., less than or equal to 4% N₂) and the compound regime (e.g., greater than or equal to 10% N₂) were analyzed. Using composite membranes 200 that are symmetric Pd-based sandwich structures, it was shown that ZrN layers having a thickness of no more than about 40 nm present a negligible resistance to H₂ transport.

Further, as illustrated by the correlation between permeability and ZrN electrical resistivity, both permeance and stability improved as resistivity was reduced, with best performance obtained from films deposited in the metallic regime at high temperature. For example, stable permeability up to at least about 6×10⁻⁸ mol H₂ m m⁻² s⁻¹ Pa^{-0.5} at 425° C. was observed in symmetric Pd—ZrN—V—ZrN—Pd membranes 200 fabricated under these conditions. By way of another example, it was observed that symmetric membranes 200 may fail at temperatures greater than 450° C., which is consistent with ZrN stability.

Depth profiling revealed the presence of significant oxygen at the ZrN—V interface after membrane fabrication, and the oxygen continued to accumulate at the ZrN—V interface during permeation with the source being the underlying V foil. It is contemplated that the O accumulation and its interaction with both ZrN and permeating H is responsible for the long transients observed in the membrane 200.

As such, the hydrogen-permeable intermetallic diffusion barriers (e.g., as formed from a group 4 nitride) as described throughout the present disclosure are a beneficial improvement to metallic membranes for hydrogen purification, and expand both the operation window and application space for deployment of composite PGM-BCC metal (e.g., group 5 metal) membranes.

In this regard, group 4 nitrides (e.g., ZrN) can be used as a hydrogen-permeable, intermetallic diffusion barrier for stable, high-temperature operation of composite PGM-BCC metal (e.g., group 5 metal) (e.g., Pd—V) membranes for hydrogen purification. ZrN was deposited by reactive sputtering. The properties and performance of films deposited in the metallic and compound regimes were compared, and screening experiments as described herein using Pd-based sandwich structures illustrate that ZrN does not significantly impede H permeation until its thickness is increased above 40 nm. In addition, stable hydrogen permeability (i.e., up to at least about 6×10⁻⁸ mol H₂ m⁻² s⁻¹ Pa^{-0.5}) was obtained in Pd—ZrN—V—ZrN—Pd composite membranes at operating temperatures of between 400° C. and 450° C., with superior performance from known diffusion barriers obtained from ZrN deposited in the metallic regime. Further, long term stability (i.e., greater than 180 hours) was obtained and the structural integrity post-testing was confirmed by XRD and TEM imaging.

It is noted that compositional profiling showed that oxygen originating in the V foil segregates to the ZrN—V interface but does not impede flux, and transient behavior observed during testing is attributed to this. In addition, ZrN may decompose at temperatures greater than 450° C., leading to rapid Pd—V interdiffusion and loss of permeability. However, with improved selectivity and permeabilities up to four times greater than Pd, the membranes described herein are an improved and cost-effective alternative for hydrogen purification operations at temperatures of about 350° C. to about 450° C.

In this regard, advantages of the present disclosure include, but are not limited to, hydrogen-permeable, intermetallic diffusion barriers used in body-centered cubic (BCC) metal membranes for use in hydrogen purification. In particular, advantages of the present disclosure include a composite membrane having a BCC metal layer (e.g., selected from a group 5 BCC metal), one or more nitride layers (e.g., selected from group 4 nitrides), and one or more platinum group metal (PGM) layers. In addition, advantages of the present disclosure include the composite membrane being symmetric in layer stacking or configuration. Further, advantages of the present disclosure include one or more of the layers being applied via reactive sputtering.

Advantages of the present disclosure also include, but are not limited to, layer thicknesses of the composite membrane ranging from about 10 nm to about 100 nm. Advantages of the present disclosure also include, but are not limited to, operating temperatures ranging from approximately room temperature (e.g., about 15° C.) to about 500° C. without rapid interdiffusion of the layers. Advantages of the present disclosure also include, but are not limited to, operating times for the composite membrane ranging up to at least about 200 hours.

While various embodiments of the present disclosure have been described in detail, it is apparent that modifications and alterations of those embodiments will occur to those skilled in the art. However, it is to be understood that such modifications and alterations are within the scope and spirit of the present disclosure, as set forth in the following claims. Further, the disclosure described herein is capable of other embodiments and of being practiced or of being carried out in various ways. It is to be understood that the phraseology and terminology used herein is for the purpose of description and should not be regarded as limiting.

A number of variations and modifications of the disclosure can be used. It would be possible to provide for some features of the disclosure without providing others. The present disclosure, in various embodiments, configurations, or aspects, includes components, methods, processes, systems and/or apparatus substantially as depicted and described herein, including various embodiments, configurations, aspects, subcombinations, and subsets thereof. Those of skill in the art will understand how to make and use the present disclosure after understanding the present disclosure. The present disclosure, in various embodiments, configurations, and aspects, includes providing devices and processes in the absence of items not depicted and/or described herein or in various embodiments, configurations, or aspects hereof, including in the absence of such items as may have been used in previous devices or processes, e.g., for improving performance, achieving ease and\or reducing cost of implementation.

The foregoing discussion of the disclosure has been presented for purposes of illustration and description. The foregoing is not intended to limit the disclosure to the form or forms disclosed herein. In the foregoing Detailed Description for example, various features of the disclosure are grouped together in one or more embodiments, configurations, or aspects for the purpose of streamlining the disclosure. The features of the embodiments, configurations, or aspects of the disclosure may be combined in alternate embodiments, configurations, or aspects other than those discussed above. This method of disclosure is not to be interpreted as reflecting an intention that the claimed disclosure requires more features than are expressly recited in each claim. Rather, as the following claims reflect, inventive aspects lie in less than all features of a single foregoing disclosed embodiment, configuration, or aspect. Thus, the following claims are hereby incorporated into this Detailed Description, with each claim standing on its own as a separate preferred embodiment of the disclosure.

Moreover, though the description of the disclosure has included description of one or more embodiments, configurations, or aspects and certain variations and modifications, other variations, combinations, and modifications are within the scope of the disclosure, e.g., as may be within the skill and knowledge of those in the art, after understanding the present disclosure. It is intended to obtain rights which include alternative embodiments, configurations, or aspects to the extent permitted, including alternate, interchangeable and/or equivalent structures, functions, ranges or steps to those claimed, whether or not such alternate, interchangeable and/or equivalent structures, functions, ranges or steps are disclosed herein, and without intending to publicly dedicate any patentable subject matter.

What is claimed is:

1. A composite metal membrane for stable and effective permeation of hydrogen during hydrogen purification to produce high purity hydrogen, comprising:
a metal foil layer, comprising a body-centered cubic metal;
at least one catalyst layer, comprising a platinum group metal; and
at least one hydrogen-permeable, intermetallic diffusion barrier, disposed between the metal foil layer and the at least one catalyst layer and comprising a group 4 nitride.

2. The composite metal membrane of claim 1, wherein the body-centered cubic metal is selected from the group consisting of vanadium (V), niobium (Nb), tantalum (Ta), and combinations thereof.

3. The composite metal membrane of claim 2, wherein the body-centered cubic metal is vanadium.

4. The composite metal membrane of claim 1, wherein the platinum group metal is selected from the group consisting of palladium (Pd), platinum (Pt), ruthenium (Ru), and combinations thereof.

5. The composite metal membrane of claim 4, wherein the platinum group metal is palladium.

6. The composite metal membrane of claim 1, wherein the group 4 nitride is selected from the group consisting of zirconium nitride (ZrN), titanium nitride (TiN), hafnium nitride (HfN), and combinations thereof.

7. The composite metal membrane of claim 6, wherein the group 4 nitride is zirconium nitride.

8. The composite metal membrane of claim 1, wherein the at least one hydrogen-permeable, intermetallic diffusion barrier has a thickness of about 20 nanometers to about 40 nanometers.

9. The composite metal membrane of claim 1, wherein:
the at least one catalyst layer comprises a first catalyst layer and a second catalyst layer, and
the at least one hydrogen-permeable, intermetallic diffusion barrier comprises a first hydrogen-permeable, intermetallic diffusion barrier, disposed between the first catalyst layer and a first side of the metal foil layer, and a second hydrogen-permeable, intermetallic diffusion barrier, disposed between the second catalyst layer and a second side of the metal foil layer.

10. A method for fabricating a composite metal membrane for stable and effective permeation of hydrogen during hydrogen purification to produce high purity hydrogen, comprising:
(a) forming a metal foil layer from a body-centered cubic group 5 metal;
(b) depositing a group 4 nitride on the metal foil layer to form at least one hydrogen-permeable, intermetallic diffusion barrier; and
(c) depositing a platinum group metal on the at least one hydrogen-permeable, intermetallic diffusion barrier to form at least one catalyst layer.

11. The method of claim 10, wherein step (b) is carried out at a temperature from about 350° C. to about 450° C.

12. The method of claim 11, wherein the temperature is about 400° C.

13. The method of claim 10, wherein at least a portion of step (b) is carried out by reactive sputtering.

14. The method of claim 13, wherein the reactive sputtering is carried out in an atmosphere comprising no more than about 4% nitrogen gas (N₂).

15. The method of claim 13, wherein the reactive sputtering is carried out in an atmosphere comprising at least about 10% nitrogen gas (N₂).

16. The method of claim 10, wherein step (b) comprises:
forming a first hydrogen-permeable, intermetallic diffusion barrier on a first side of the metal foil layer; and
forming a second hydrogen-permeable, intermetallic diffusion barrier on a second side of the metal foil layer; and
wherein step (c) comprises:
forming a first catalyst layer on the first hydrogen-permeable, intermetallic diffusion barrier; and
forming a second catalyst layer on the second hydrogen-permeable, intermetallic diffusion barrier.

17. A composite metal membrane for stable and effective permeation of hydrogen during hydrogen purification to produce high purity hydrogen, comprising:
a metal foil layer, comprising a body-centered cubic metal;
a first platinum group metal catalyst layer;
a second platinum group metal catalyst layer;
a first group 4 nitride layer forming a first hydrogen-permeable, intermetallic diffusion barrier, the first group 4 nitride layer disposed between a first side of the metal foil layer and the first platinum group metal catalyst layer; and
a second group 4 nitride layer forming a second hydrogen-permeable, intermetallic diffusion barrier, the second group 4 nitride layer disposed between a second side of the metal foil layer and the second platinum group metal catalyst layer.

18. The composite metal membrane of claim 17, wherein the body-centered cubic metal is a group 5 metal selected from the group consisting of vanadium (V), niobium (Nb), tantalum (Ta), and combinations thereof.

19. The composite metal membrane of claim 17, wherein the first platinum group metal catalyst layer and the second platinum group metal catalyst layer each comprise a platinum group metal selected from the group consisting of palladium (Pd), platinum (Pt), ruthenium (Ru), and combinations thereof.

20. The composite metal membrane of claim 17, wherein the first group 4 nitride layer and the second group 4 nitride layer each comprise a group 4 nitride selected from the group consisting of zirconium nitride (ZrN), titanium nitride (TiN), hafnium nitride (HfN), and combinations thereof.
